(19) United States
(12) Patent Application Publication
(10) Pub. No.: US 2023/0058127 A1
(43) Pub. Date: Feb. 23, 2023

(54) SERVER ARRANGEMENT AND RELATED METHODS FOR PERFORMING FINANCIAL OPERATIONS

(71) Applicant: Banque Nationale du Canada, Montreal (CA)

(72) Inventors: Olivier BERROD, Montreal (CA); Jose Angel FRANCO NAVARRO, Brossard (CA); Martin GAUTHIER, Montreal (CA); Francois LORANGER, Repentigny (CA); Alain LAVOIE, Montreal (CA); Roger MILLER, Lachine (CA); Christopher SÉBASTIEN, Montreal (CA)

(21) Appl. No.: 17/981,222

(22) Filed: Nov. 4, 2022

Related U.S. Application Data
(63) Continuation of application No. 17/312,653, filed on Jun. 10, 2021, now abandoned.

(30) Foreign Application Priority Data
Dec. 14, 2018 (CA) 3027815

(51) Int. Cl. G06Q 20/10; G06Q 20/02; G06Q 20/38; G06Q 20/40; G06Q 40/02

(52) U.S. Cl. CPC G06Q 20/108; G06Q 20/02; G06Q 20/389; G06Q 20/4014; G06Q 40/02

(57) ABSTRACT

The present disclosure relates to server arrangement for operating, controlling and managing financial operations. The server arrangement implements a shared ledger for recording and storing financial data (e.g., financial transactions) of accounts that are supported by distinct licensed core banking engines. This may allow the server arrangement to implement the licensed core banking engines to perform financial transactions without the use of a payment processor. The server arrangement implements a virtual marketplace where banking services are rendered available to users. Each banking service may be sold by one of the licensed banks to a banking client entity and the banking client entity may select and bundle the banking services of the licensed banks and offer the bundle for sale to the clients in the virtual marketplace. This may facilitate operation for the banking client entities and management of financial assets for the user.

### CROSS-REFERENCE TO RELATED APPLICATIONS

This application is a continuation of U.S. patent application Ser. No. 17/312,653, filed Jun. 10, 2021, which is a U.S. national stage entry under 35 U.S.C. § 371 of PCT International Patent Application No. PCT/CA2019/051822, filed Dec. 16, 2019, which claims the benefit of CA Patent Application No. 3,027,815, filed Dec. 14, 2018, the contents of each of which are incorporated herein by reference into the subject application.

### FIELD

The present disclosure relates generally to a server arrangement and to associated methodologies for providing banking services, in particular to operate, control and manage financial operations.

### BACKGROUND

Currently, banking institutions typically operate in silos. In other words, a banking institution offers to its customers a range of financial products, such as accounts or mortgages but the choices are limited. That is a disadvantage because the customer is restricted to the financial services offered by a particular banking institution. Moreover, due to technological limitations, there is no possibility to seamlessly provide a mix of financial services offered by different banking institutions.

### SUMMARY

In accordance with an aspect, this disclosure relates to a server arrangement for hosting a marketplace for financial services, the server arrangement including one or more CPUs, a memory readable by the processor and storing instructions, the instructions when executed by the one or more CPUs implementing a method including the steps of: receiving a request from a financial services merchant to offer a financial product on a virtual marketplace implemented by the server arrangement; in response to the request from the financial services merchant making available to customers of the marketplace a financial product, wherein the marketplace is configured to make available to customers of the marketplace a range of financial products implemented in an environment comprising at least a first financial product and a second financial product, wherein the first financial product is offered by a first bank associated with a first financial services merchant and the second financial product is offered by a second bank associated with a second financial services merchant, the customer accessing both financial products through a user interface in which financial transactions of both the first and second product are combined for display to the customer, the first bank and the second bank being linked by an inter-bank transfer rail associated with a shared ledger whereby a transaction including a monetary transfer between the first and the second banks over the inter-bank transfer rail is recorded on the shared ledger.

In accordance with another aspect, this disclosure relates to a server arrangement implementing a plurality of banks to perform financial transactions, the sever arrangement including one or more CPUs and memory encoded with instructions that can be executed by the one or more CPUs, the instructions when executed implementing: a first banking engine associated with a first bank, the first bank associated with a first financial services merchant; a second banking engine associated with the second bank, the second bank associated with a second financial services merchant, the first bank being distinct from the second bank; a shared leger in communication with the first banking engine and with the second banking engine; the shared ledger configured for recording a financial transaction associated with a customer that has a first account maintained on the first banking engine and a second account maintained on the second banking engine, wherein the financial transaction includes a monetary transfer between the first and the second accounts and performed over an inter-bank transfer rail linking the first banking engine with the second banking engine and wherein the shared ledger is associated with the inter-bank transfer rail to record monetary transactions performed over the inter-bank transfer rail.

In accordance with another aspect, this disclosure relates to a server arrangement implementing a shared ledger associated with an inter-transfer rail communicating with a plurality of banking engines, the server arrangement including one or more CPUs and memory encoded with instructions that can be executed by the one or more CPUs, the instructions when executed implementing a shared ledger layer configured to record transactions for multiple bank customers, where each bank customer has a first account maintained by a first banking engine of the plurality of banking engines and a second account maintained by a second banking engine of the plurality of banking engines.

In accordance with another aspect, this disclosure relates to a server arrangement for providing a user interface to a plurality of customer computing devices associated with customers performing banking operations via the user interface, the server arrangement including one or more CPUs and memory encoded with instructions that can be executed by the one or more CPUs, the instructions when executed implementing: a user interface provided to a customer on a customer computing device, the user interface providing tools to enable a customer to login with an identify and authentication code; a communications layer for receiving the identify and authentication code, communicating with the user interface, and with any banking engines; a database of customer profiles, where upon receipt of a valid identity and authentication code, the database provides the communications layer with a profile related to the customer, the profile including the list of financial products used by the customer; the communications layer enabled to provide information to and receive information from the banking engines and combine information from two or more banking engines for communication to the user interface and display of the combined information to the customer.

In accordance with another aspect, this disclosure relates to a server arrangement for providing a banking portal to a plurality of computer clients associated with customers performing banking transactions via the banking portal, the server arrangement including one or more CPUs and memory encoded with instructions that can be executed by the one or more CPUs, the instructions when executed implementing: a. a front-end layer including a Graphical User Interface providing tools to a customer remotely accessing the banking portal, the tools including: i. a first tool to access a first account opened on a first banking engine associated with a first bank; ii. a second tool to access a second account opened on a second banking engine associated with a second bank, wherein the first and the second banking engines are distinct from each other; b. a communication layer, configured for establishing a communication with the first banking engine and with the second banking engine to provide: i. transaction data to the customer via the first tool, derived from the first banking engine and associated with the first account; ii. transaction data to the customer via the second tool, derived from the second banking engine and associated with the second account.

In accordance with another aspect, this disclosure relates to a server arrangement for generating a software code of a banking engine, the software code when executed by one or more CPUs configured to provide a customer with banking services, the server arrangement configured for implementing: a front end layer providing a user interface exposing to a financial services merchant a range of software modules for selection to be integrated into the banking engine; the user interface configured to provide customization tools to selectively customize one or more parameters of the selected software modules to be integrated into the banking engine; a banking engine generator, configured to generate the software code including: a front-end layer to communicate to a customer who has selected the financial product based on the customized software module selected and customized by the financial services merchant and configured with the customization tools; a core layer including a plurality of software modules for implementing respective ones of the financial products; an interconnect layer for connection to a inter-bank transfer rail.

In accordance with another aspect, this disclosure relates to a computer-implemented method for transferring funds between first and second financial products, the first financial product being implemented by a first software module in a first custom bank engine operated by a first financial services merchant, and the second financial product being implemented by a second software module in a second custom bank engine operated by a second financial services merchant. The method includes: transmitting, from a customer device, a request to transfer funds from the first financial product to the second financial product; receiving the request by a first server implementing the first custom bank engine and, responsive to said request, operating the first software module to debit the first financial product and recording the debit in a first private ledger associated with the first custom bank; transmitting, by the first server via an inter-bank transfer rail, a request to credit the second financial product, receiving, by a second server implementing the second custom bank engine, via the inter-bank transfer rail, the request to credit the second financial product; operating the second software module to credit the second financial product, and recording the credit in a second private ledger associated with the second custom bank engine; recording the debit from the first financial product and the credit to the second financial product in a shared ledger on the inter-bank transfer rail; transmitting, from the first server to the customer device, an updated balance of the first financial product; transmitting, from the second server to the customer device, an updated balance of the second financial product; and displaying the updated balance of the first financial product and the updated balance of the second financial product on a common graphical user interface (GUI) of the customer device.

In accordance with another aspect, this disclosure relates to an electronic banking system allowing transfers between first and second financial products, the first and a second financial products being operated by independent custom bank engines. The electronic banking system includes: a first server implementing a first custom bank engine, said first custom bank engine being operated by a first financial services merchant and comprising a first software module comprising computer code executable to implement the first financial product, and a first private ledger for recording transactions to and from the first financial product; a second server implementing a second custom bank engine, said second custom bank engine being operated by a second financial services merchant and comprising a second software module comprising computer code executable to implement the second financial product, and a second private ledger for recording transactions to and from the second financial product; and an inter-bank transfer rail operatively connecting the first server and the second server and allowing the first custom bank engine and the second custom bank engine to inter-communicate, the inter-bank transfer rail comprising a shared ledger for recording a request from one of the first or second servers to transfer funds between the first and second financial products, and for recording a confirmation of receipt of the request from the other one of the first and second servers; and a customer device in operative communication with the first and second server, the customer device being operable to transmit a request to the first server to transfer funds from the first financial product to the second financial product over the inter-bank transfer rail, the customer device being further configured to receive an updated balance of the first financial product from the first server and an updated balance of the second financial product from the second server following the transfer, and display the updated balance of the first and second financial products on a common GUI.

In accordance with another aspect, this disclosure relates to a non-transitory computer-readable medium having instructions stored thereon which, when executed by at least one processor, cause the at least one processor to carry out a method for transferring funds between first and second financial products, the first financial product being implemented by a first software module in a first custom bank engine operated by a first financial services merchant, and the second financial product being implemented by a second software module in a second custom bank engine operated by a second financial services merchant. The method includes: transmitting, from a customer device, a request to transfer funds from the first financial product to the second financial product; receiving the request by a first server implementing the first custom bank engine and, responsive to said request, operating the first software module to debit the first financial product and recording the debit in a first private ledger associated with the first custom bank; transmitting, by the first server via an inter-bank transfer rail, a request to credit the second financial product, receiving, by a second server implementing the second custom bank engine, via the inter-bank transfer rail, the request to credit the second financial product; operating the second software module to credit the second financial product, and recording the credit in a second private ledger associated with the second custom bank engine; recording the debit from the first financial product and the credit to the second financial product in a shared ledger on the inter-bank transfer rail; transmitting, from the first server to the customer device, an updated balance of the first financial product; transmitting, from the second server to the customer device, an updated balance of the second financial product; and displaying the updated balance of the first financial product and the updated balance of the second financial product on a common GUI of the customer device.

In accordance with another aspect, this disclosure relates to a computer-implemented method for interacting with first and second financial products, the first financial product being implemented by a first software module in a first custom bank engine, and the second financial product being implemented by a second software module in a second custom bank engine. The method includes: authenticating a customer at a customer device and determining whether the customer is authorized to interact with the first and second financial products; and if the customer is authorized: a) transmitting, from the customer device, a first request to the first custom bank engine; b) receiving the first request by a first server implementing the first custom bank engine and, responsive to said request, operating the first software module to respond to the request from the customer device without authenticating the customer by the first custom bank engine; c) receiving a second request by a second server implementing the second custom bank engine and, responsive to said request, operating the second software module to respond to the second request without authenticating the customer by the second custom bank engine; d) transmitting, by the second server, second information relating to the second request from the customer device; e) transmitting, by the first server, first information relating to the first request from the customer device; f) receiving at least some of the first and second information on the customer device; and g) displaying the at least some of the first and second information on a common GUI of the customer device.

According to another aspect, this disclosure relates to an electronic banking system for interacting with first and second financial products, the first and second financial products being operated by independent custom bank engines. The electronic banking system includes a customer device configured to authenticate a customer and determine whether the customer is authorized to interact with the first and second financial products and, if the customer is authorized: a) establish a communication link with: i. a first server implementing a first custom bank engine, said first custom bank engine being operated by a first financial services merchant and comprising a first software module comprising computer code executable to implement the first financial product, the first server being configured to receive a first request and, responsive to said request, operate the first software module to respond to the request from the customer device without authenticating the customer by the first custom bank engine; ii. a second server implementing a second custom bank engine, said second custom bank engine being operated by a second financial services merchant and comprising a second software module comprising computer code executable to implement the second financial product, the second server being configured to receive a second request and, responsive to said second request, operate the second software module to respond to the second request from the customer device without authenticating the customer by the second custom bank engine; b) transmit the first request to the first custom bank engine; c) receive at least some first and second information from the first and second servers, the first and second information respectively relating to the first and second requests; and d) display the at least some of the first and second information on a common GUI.

According to another aspect, this disclosure relates to a non-transitory computer-readable medium having instructions stored thereon which, when executed by at least one processor, cause the at least one processor to carry out a method for interacting with first and second financial products, the first financial product being implemented by a first software module in a first custom bank engine, and the second financial product being implemented by a second software module in a second custom bank engine. The method includes: authenticating a customer at a customer device and determining whether the customer is authorized to interact with the first and second financial products; and if the customer is authorized: a) transmitting, from the customer device, a first request to the first custom bank engine; b) receiving the first request by a first server implementing the first custom bank engine and, responsive to said request, operating the first software module to respond to the request from the customer device without authenticating the customer by the first custom bank engine; c) receiving a second request by a second server implementing the second custom bank engine and, responsive to said request, operating the second software module to respond to the second request without authenticating the customer by the second custom bank engine; d) transmitting, by the second server, second information relating to the second request from the customer device; e) transmitting, by the first server, first information relating to the first request from the customer device; f) receiving at least some of the first and second information on the customer device; and g) displaying the at least some of the first and second information on a common GUI of the customer device.

According to another aspect, this disclosure relates to a computer-implemented method for providing a user interface to a customer device for interacting with a plurality of financial products implemented by a plurality of custom bank engines and offered to the customer through a financial services marketplace. The method includes: sending a request from the customer device to interact with the plurality of financial products; receiving the request at a management server, and retrieving a profile associated with the customer from a customer profile database, said customer profile containing a list of financial products to which the customer has subscribed through the financial services marketplace; for at least two financial products in the customer profile: i. establishing a communication link between the management server and a banking server hosting a banking engine which implements the financial product; ii. receiving, by the management server, transaction information relating to the financial product from the banking engine implementing the financial product; transmitting, from the management server to the customer device, at least some of the received transaction information relating to the financial products in the customer profile; and causing at least some of the received transaction information to be combined and displayed simultaneously on the user interface of the customer device.

According to another aspect, this disclosure relates to a system for providing a user interface to a customer for interacting with a plurality of financial products implemented by a plurality of custom bank engines and offered to the customer through a financial services marketplace. The system includes: a plurality of banking servers, each banking server hosting at least one custom bank engine implementing a financial product offered on the financial services marketplace; a management server in operative communication with the plurality of banking servers, the management server being configured to communicate with the plurality of banking servers to retrieve transaction information from the plurality of custom bank engines relating to the plurality of financial products to which the customer is subscribed; and a customer device in operative communication with the management server, the customer device comprising the user interface, a communications module and a processor, said processor being configured to receive at least some of the transaction information from the management server via the communications module, and to simultaneously display at least some combined transaction information on the user interface.

According to another aspect, this disclosure relates to an electronic banking system allowing transfers between first and second financial products to which a customer has subscribed, the first and a second financial products being operated by independent custom bank engines and offered to customers on a common financial services marketplace. The electronic banking system includes: a first server implementing a first custom bank engine, said first custom bank engine comprising a first software module comprising computer code executable to implement the first financial product, and a first private ledger for recording transactions to and from the first financial product;
a second server implementing a second custom bank engine, said second custom bank engine comprising a second software module comprising computer code executable to implement the second financial product, and a second private ledger for recording transactions to and from the second financial product; and an inter-bank transfer rail operatively connecting the first server and the second server and allowing the first custom bank engine and the second custom bank engine to inter-communicate, the inter-bank transfer rail comprising a shared ledger for recording a request from one of the first or second servers to transfer funds between the first and second financial products, and for recording a confirmation of receipt of the request from the other one of the first and second servers.

These and other aspects of this disclosure will now become apparent to those of ordinary skill in the art upon review of a description of embodiments that follows in conjunction with accompanying drawings.

### BRIEF DESCRIPTION OF THE DRAWINGS

A detailed description of embodiments is provided below, by way of example only, with reference to drawings annexed hereto, in which:

FIG. 1 is a block diagram showing an example of an ecosystem allowing creating and distributing a range of financial products through banks created and operated within the ecosystem;

FIG. 1a is a block diagram illustrating the structure of a software module on which a financial product is based;

FIG. 2 shows in greater detail the software architecture of the financial products offering platform and the bank generation platform;

FIG. 3 illustrates the architecture of a banking engine generated by the bank generation platform;

FIG. 4 is a flowchart illustrating the steps performed when a banking engine is generated by the bank generation platform shown in FIG. 2;

FIG. 5 is a block diagram illustrating the structure of an inter-banking transfer rail;

FIG. 6 is a flowchart illustrating the operation of the inter-banking transfer rail;

FIG. 7 is a diagram of a network infrastructure implementing a virtual marketplace;

FIGS. 7A to 7F are block diagrams of software components of a server implementing the virtual marketplace;

FIG. 8 illustrates a customer mobile on which is implemented a GUI allowing the customer to choose financial products made available on the virtual marketplace of FIG. 7;

FIG. 9 illustrates components of the ecosystem functionally related to each other to enable a customer to conduct banking operations;

FIG. 9A is a sequence diagram illustrating the interoperation of the components of FIG. 9;

FIG. 10 is a block diagram of a rewards system;

FIGS. 11 and 12 are flowcharts of the operation of the rewards system of FIG. 10;

FIG. 13 illustrates components of an ecosystem in which banking engines are implemented as collections of containers;

FIG. 13A is a sequence diagram illustrating the interoperation of the components of FIG. 13.

In the drawings, embodiments are illustrated by way of example. It is to be expressly understood that the description and drawings are only for purposes of illustration and as an aid to understanding, and are not intended to be and should not be limitative.

### DETAILED DESCRIPTION

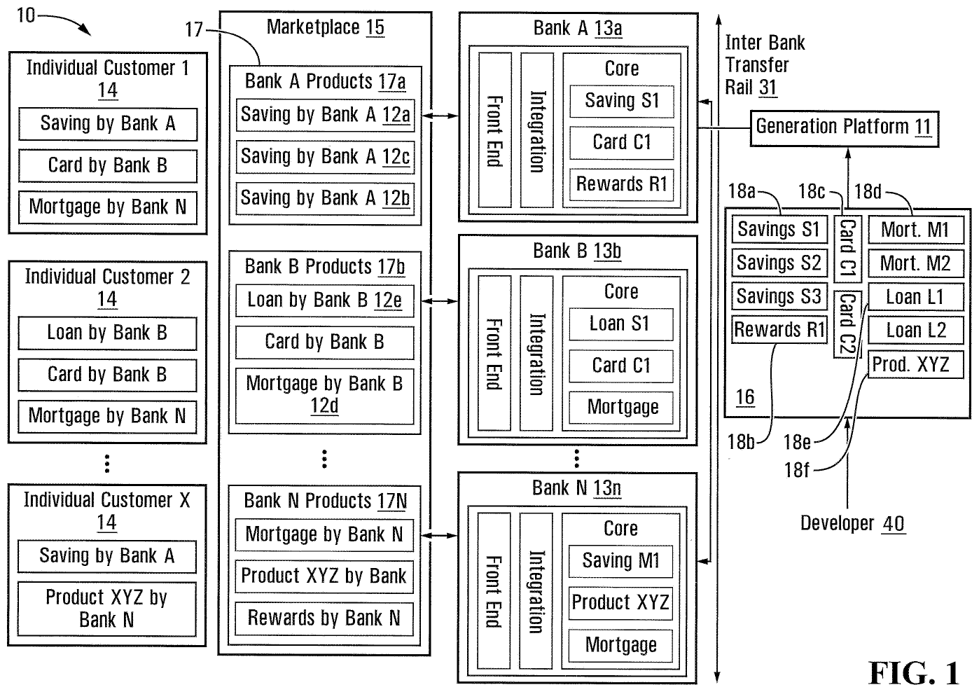

FIG. 1 is a block diagram of an ecosystem 10 allowing the distribution of customized financial products 12 to customers 14. The ecosystem 10 includes a software module offering platform 16 which is a computer-implemented system storing a range of different software modules 18 that constitute the building blocks of highly customized financial products 12 that can be offered to customers 14. In other words, each software module 18a-f includes the program code to implement a particular financial product that a customer may use to obtain financial services. Hence, the key component of the software module offering platform 16 is a machine-readable memory storage encoded with software code which when executed by a CPU will implement the range of software modules 18. Examples of financial products that can be built on the basis of the software modules 18 include savings accounts 18a, rewards accounts 18b, credit card accounts 18c, mortgage accounts 18d and loan accounts 18e. Other products not listed in the figure can include business checking accounts and business credit cards, and specialized loan products targeting certain types of industries. Non-limiting examples of such loan products include loans against collateral (such as machinery, buildings, equipment, etc.) and loans to companies with regular recurring revenue. Other financial products may include payroll products for managing payroll and paying employees, human resources products for managing employees, budgeting products, accounts payable products for managing cash flow, accounting products for creating monthly, quarterly and annual financial reports, customer relation management products and accounts receivable products. Some of these financial products either take customer deposits (such as checking, savings and investment accounts) while others provide funds in the form of loans (such as credit cards, mortgages, personal and financial loans). These financial products are typically subject to banking regulations and the requirement in certain jurisdictions of banking licenses. Other financial products offer services which do not handle or take custody of funds, including payroll, human resources, budgeting, accounts payable and accounts receivable management financial products. Certain of these financial products are targeted at individual customers (such as credit cards, mortgages, checking and savings accounts) while others are targeted at business customers (such as loans, business credit cards, commercial checking accounts, human resources solutions, etc.). Herein it is understood that customer may mean either individuals or businesses or both, each of which may be offered financial products targeted to their needs through the ecosystem 10.

The software module offering platform 16 includes a software module upload functionality 21 which typically will be implemented as a developer interface allowing a developer 40, such as a Fintech, a bank (for example JP Morgan) or a software provider (for example IBM, Oracle, Mambu) that has developed a particular software module 18 to upload the software module 18 that enables a related financial product 12, to the software module offering platform 16. For example, a developer 40 may wish to introduce a novel credit card product to the banking industry targeting a specific demographic, for example millennials. The new product will analyze the carbon impact of the credit card holder's purchases and provide feedback to the holder. The developer 40 will create a credit card software module with the necessary features to track and analyze individual transactions and upload the software module to the software module offering platform, where financial services merchants 29 wishing to offer products to millennials can choose to offer the novel credit card to their customers 14. The software module offering platform 16 thereby acts as a platform for offering software modules to financial services merchants 29 and generates competition to improve financial product offerings in the banking industry.

The structure of each software module 18 is shown in FIG. 1 a. The software module includes a core code component 100, which is the program code that when executed will provide the intended functionality of a financial product, such as the functionality of a credit card account or a savings account. As can be appreciated, the core code component 100 can be configured to provide a variety of different functions as required to implement a given financial product. For example, for a checking account software module which offers a checking account financial product, the core code component 100 can include program code which enables balance queries, debits and credits, calculations of fees related to the checking account, calculation of interests on balances etc. Of course, other functions can be provided depending on the nature of the financial product being offered. The core component 100 can further be configured to allow the software module 18 to communicate with other software modules and/or with other components of the ecosystem 10, for example via an API.

The software module 18 further includes a customization component 102 allowing a financial services merchant 29 to customize the software module 18 in order to provide the financial product with the desired features. The customization component includes customizable parameters. Non-limiting examples of customizable parameters include interest rate information and monetary values acting as triggers for certain events or conditions and identifiers of other software modules, among others. The customizable parameters will likely be different from one financial product to another. To assist with the customization of those parameters in a user-friendly fashion, the customization component can further include a customization functionality, which exposes to the financial services merchant those customizable parameters such that they can be set as desired. In some embodiments, the customizable parameters can include default values predefined by the developers 40 which can later be modified by the financial services merchant 29 selecting the software module 18, if desired.

Returning to FIG. 1, coupled to the software module offering platform 16 is a bank generation platform 11. In response to selection of the desired software modules 18 corresponding to the desired financial products by financial services merchant 29, the bank generation platform 11 can generate a banking engine 13 built around the selected software modules 18. The banking engine 13 is a functioning whole that implements the desired financial products such that customers can use them to conduct financial transactions.

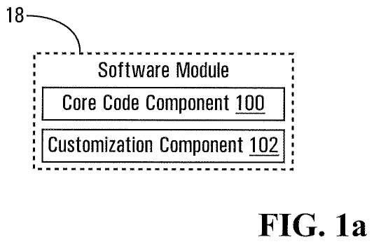

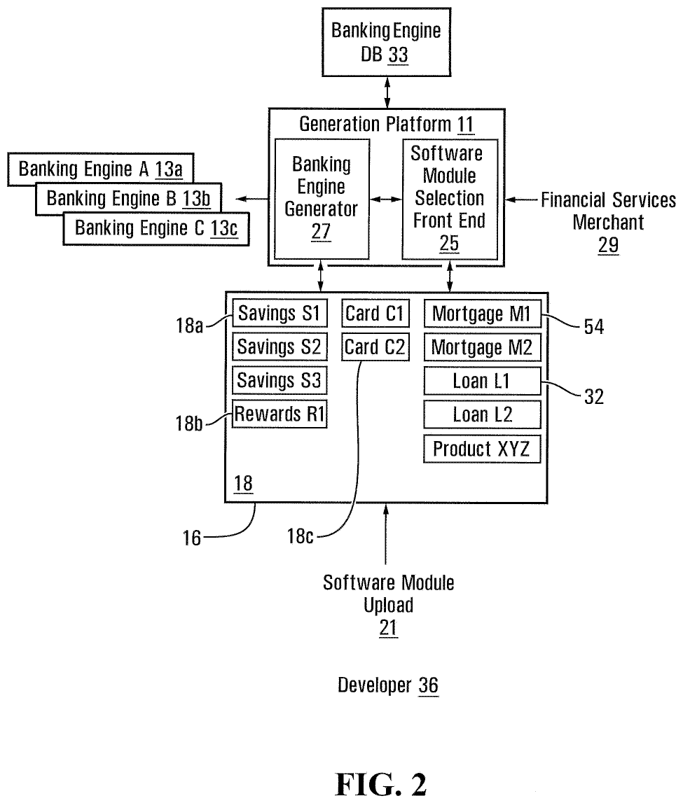

The bank generation platform 11 includes two main components, shown in FIG. 2, namely the software modules selection and customization front end 25 and the banking engine generator 27. The software modules selection and customization front end 25 comprises a financial services merchant interface, which exposes for selection to a financial services merchant 29 the software modules 18 provided on the software module offering platform 16. The financial service merchant interface can include help functions to explain what the various customizable parameters of financial products are and how they can be set. Also, the financial service merchant interface may include validation logic such that the parameters the financial services merchant may customize remain within acceptable boundaries. The software modules selection and customization front end 25 also exposes to the financial service merchant the customizable financial parameters of the selected software modules and provides the necessary tool for customization. In response to the selection and customization of the desired software modules 18 by the financial services merchant 29, the banking engine generator 27 will assemble the individual software modules 18 into a banking engine 13.

Broadly described, assembling the individual software modules 18 comprises functionally linking the software modules 18 such that they can operate within the context of the banking engine 13. For example, this can include initiating communication protocols allowing the individual software modules 18 to intercommunicate and/or to communicate with other components of the ecosystem 10 external to the banking engine 13. This can further includes initiating other components of the banking engine 13 to enable the operation of the software modules 18, such as a communications bus and/or a private ledger, as will be described in more detail herein after.

In some embodiments, generating the banking engine 13 can further comprise functionally linking the banking engine 13 such that it can intercommunicate with other banking engines and/or other components of the ecosystem 10. For example, upon generating a new banking engine 13, a banking engine database 33 can be updated to include a record of the new banking engine 13 and a reference thereto, such as a unique ID and/or a virtual address corresponding to the new banking engine 13. This database can be subsequently queried to identify, locate and communicate with the new banking engine 13 when required. As can be appreciated, the banking engine database 33 can be hosted on any server accessible within the ecosystem. As can be appreciated, in some embodiments, the banking engine database 33 can be combined with the customer profile database 804 discussed below.

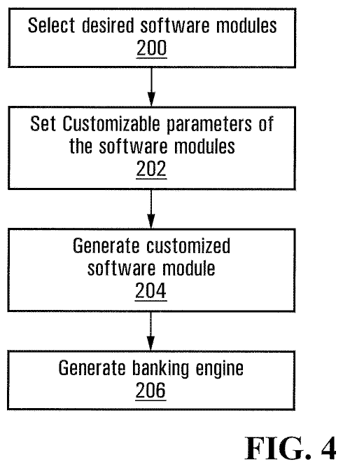

The flowchart at FIG. 4 provides additional details of the bank generation process. At step 200 the financial services merchant 29 interacts with the financial services merchant interface of the software module selection and customization front end 25 to select the software modules 18 corresponding to the desired financial products that the desired banking engine 13 should provide. After all the individual software modules 18 have been selected, they are individually customized at step 202. For each software module 18 the customization component 102 is executed to expose to the financial services merchant 29 the available customization parameters through the financial service merchant interface such that they can be set as desired.

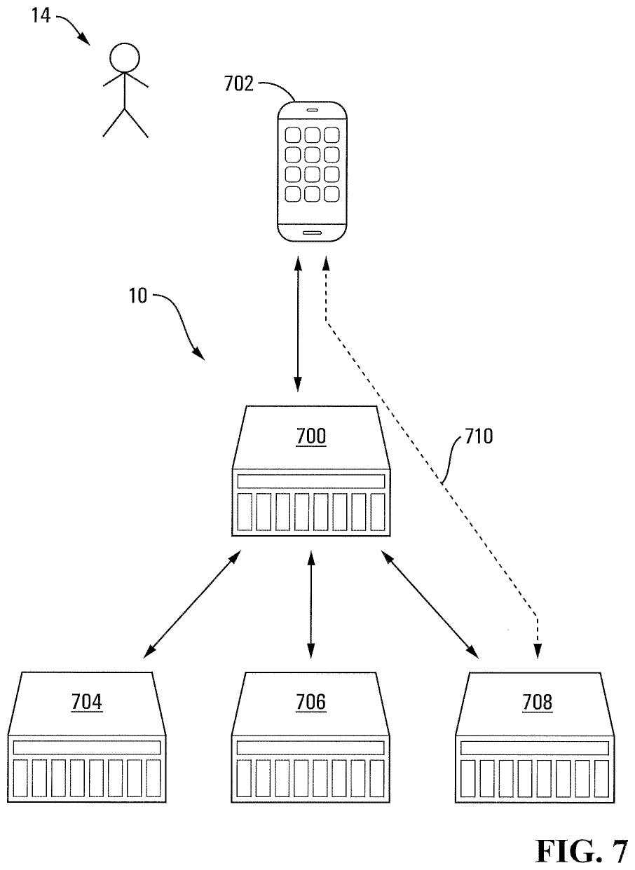

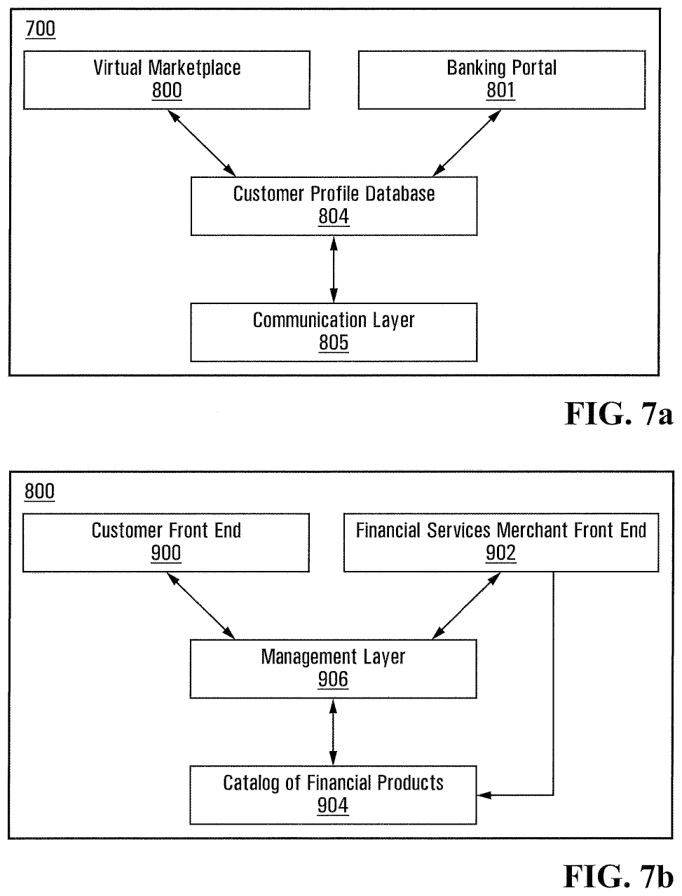

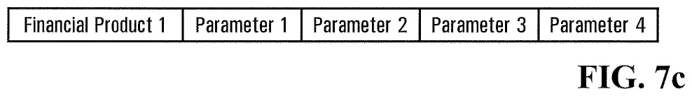

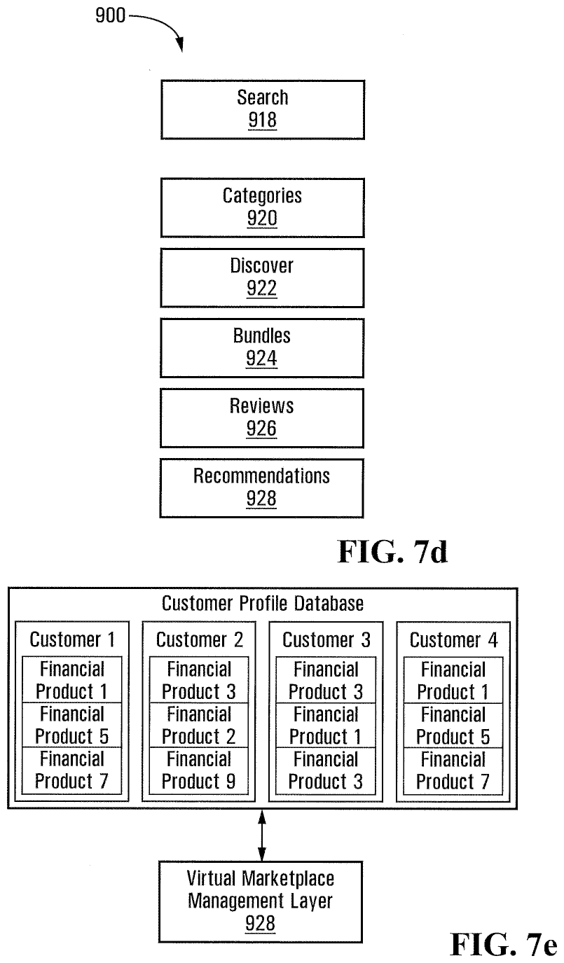

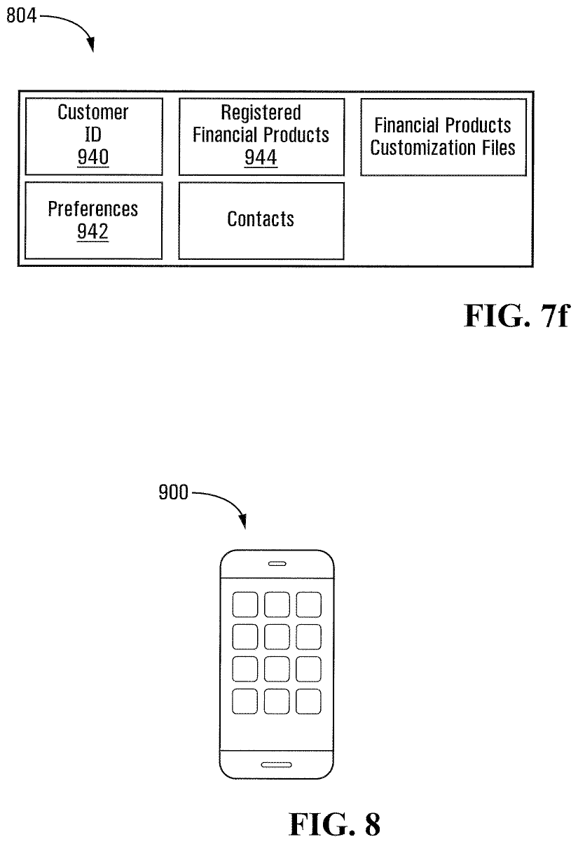

In one embodiment shown at FIG. 7c, each software module may be associated with a profile containing a file where the customized parameters associated with that software module, such as the followings, are stored:
1. Rate information. In the case of a checking account, rate information may refer to the interest rate on the sum deposed in the account. For a mortgage account, rate information may refer to the interest rate on the mortgage. For a credit card account, rate information may refer to the interest rate on the balance of the credit card.
2. Factors modifying the rate information of the financial product, such as the modification of the interest rate for a savings account where the balance exceeds a certain threshold or for a credit card after purchases made at a certain store, etc.
3. Currency information—Canadian dollars, US dollars, etc.
4. Type of products or services the account is designed for.
5. Artwork or branding in order to provide a unique use and feel to the customers that will be interacting with the financial product implemented by the customized software module.
6. Identifiers for other linked software modules, in the same bank engine or in other bank engines, that are linked to the software modules being customized.
7. Factors modifying the interest rate of the financial product, such as the interest rate changes for a savings account where the balance on the financial product implemented by the linked software module exceeds a certain threshold or the interest rate for a credit card after purchases made at a certain store, etc.

For example, parameter 1 may be the interest rate of the account and how the interest rate varies with the account balance. For instance, the interest rate that the account holder, namely the customer 14, earns may be set at 1% when the balance is below $1000, set at 1.5% when the balance is in the range of $1000 to $2000 and set at 2% when the account balance is upwardly of $2000. Similarly, another parameter of a credit card account C1 24 customizable by the financial service merchant 29 may be the selection by the financial services merchant of a group of expenses categories from which the customer 14 may choose in order to receive a reward for expenses in those categories. An example is for purchases of any pet-related products, a 4% cash-back is applied. So if the cardholder, namely the customer 14, has any pets and purchases food or veterinarian services, the customer benefits from a 4% cash-back. As to the software module 18 implementing a loan account L1 28, customizable parameters may include the type of products or services to which the loan applies and the interest rate, for example the loan is directed to veterinarian services to treat specific pet conditions.

Parameters 6 and 7 are examples that may be useful to a financial services merchant for the creation of bundles of financial products, as further described below.

At step 204, the software modules 18 become customized software modules and reflect the desired financial product features that the financial services merchant 29 wants to provide to customers.

Step 206 is the final step of the process where the customized software modules 18 are assembled in a functioning whole, namely a banking engine, that in operation provides financial or banking services to customers on the basis of the desired financial products implemented by the customized software modules.

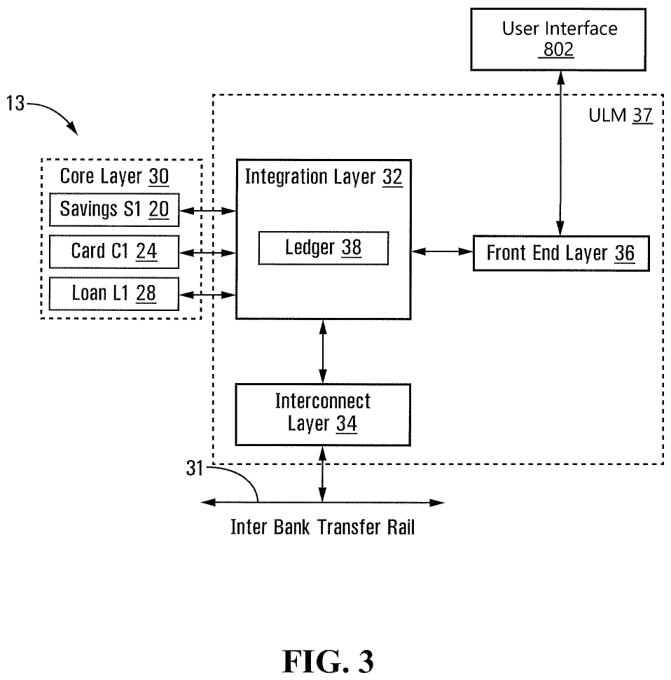

FIG. 3 illustrates the software architecture of the banking engine 13 produced by the bank generation platform 11. The banking engine 13 includes two main components, namely a core layer 30, and a communications bus 37, referred to hereinafter as a universal layer manager (ULM). The core layer 30 includes the software modules 18 implementing the financial products 12 that were selected by the financial services merchant 29 when the banking engine 13 is generated. In this example, the core layer 30 includes three software modules 18 respectively implementing the following financial products 12: a savings account S1 20, a credit card account C1 24 and a loan account L1 28. In other words, the banking engine 13 is configured to provide to customers 14 the above three financial products 12, as further described below.

The ULM 37 enables the software module 18 in the core layer 30 to communicate with one another, while also allowing the software modules 18 to communicate with software modules on other banking engines and with a user interface 802. More specifically, in the present embodiment, the ULM 37 comprises an integration layer 32, an interconnect layer 34, and a front-end layer 36.

The integration layer 32 functionally links the software modules 18 that constitute the core layer 30 such that they can interoperate. In particular, the integration layer 32 provides APIs exposing functions which allow the software modules in the core layer 30 to communicate therethrough. A ledger 38 is a component of the integration layer 32. The ledger 38 records financial transactions performed in connection with any one of the software module 18 making up the core layer 30. The ledger 38 can be referred to as a private ledger, as it only records transactions concerning the software modules 18 on the banking engine 13 where it resides. Moreover, the ledger 38 can only be written or directly accessed by resources also residing on the banking engine 13. For example, if a monetary transfer is made from the software module 18 implementing savings account S1 20 to the software module implementing credit card account C1 24, that transaction would be recorded on the ledger 38. Similarly, if a monetary transaction is performed between any one of the software modules 18 of the core layer 30 and any one of the software module of another banking engine within the ecosystem 10, that transaction would be recorded on the ledger 38 of banking engine 13, in addition to the ledger of the other banking engine. However, transactions between software modules of banking engines will not be recorded on the private ledger of a banking engine 13 that does not have any software modules involved in the transaction. As will be described in more detail hereinafter, a shared ledger 54 can be provided to record transactions occurring on and/or between all banking engines in the ecosystem 10.

The interconnect layer 34 is the interface between the integration layer 32 and an inter-bank transfer rail 31. The inter-bank transfer rail 31 is an interaction mechanism functionally linking banking engines 13 within the ecosystem 10, such that financial transactions can be carried out between different banking engines 13 that are connected to the inter-bank transfer rail 31. As can be appreciated, the interconnect layer 34 provides APIs exposing functions allowing the different banking engines 13 (and their corresponding software modules) to communicate with one another. The structure and operation of the inter-bank transfer rail 31 will be described in more detail later.

The front-end layer 36 provides an interface between the integration layer and user interface 802. As can be appreciated, the user interface 802 can include a customer interface allowing a customer of the custom bank A implemented by the banking engine 13 to use the financial products 12 implemented by software modules 18 constituting the core layer 30. As can be appreciated, the front-end layer 36 provides APIs exposing functions allowing the user interface 802 to interact with the software modules of the banking engine 13.

Referring back to FIG. 4, at step 206, the banking engine 13 is generated, and thus receives the customized software modules produced at the previous step 204 that constitute the core layer and adds to them the other components of the banking engine necessary to produce the functioning whole, namely the integration layer 32, the interconnect layer 34 and the front end layer 36. It should be noted that the integration layer 32, the interconnect layer 34 and the front end layer 36 are not intended to vary, from a core functional perspective, from one banking engine 13 to another, accordingly their functionalities are standardized. So, the integration layer 32, the interconnect layer 34 and the front end layer 36, are software components that are re-used every time a banking engine 13 is produced with little or no customization.

When a banking engine 13 is run, it operates as a custom bank, from the perspective of a customer. Hence here we describe a customer as being a customer of a custom bank, implemented by a banking engine. Referring to FIG. 1, customer 1 14 is a customer of custom bank A, implemented by banking engine 13a which is connected to the interbank transfer rail 31 to bank engine 13b of custom bank B. To run a banking engine 13, the code generated by the process of FIG. 4 is executed by a computing apparatus comprising memory and a processor. In the present configuration, the computing apparatus is configured to carry out various functionalities (i.e. services) of the banking engine 13 and can therefore be referred to as a server. As can be appreciated, in some embodiments, a single server can be provided to carry out all functions of banking engine 13. In other embodiments, however, a plurality of servers can be provided, for example each carrying out functions of individual software modules which form part of banking engine 13.

As can be appreciated a server can be implemented on a single computing device and/or can be distributed across several computing devices. For example, in some embodiments, all the software modules of the banking engine can be implemented on a single computing device, whereas in other embodiments, one or more of the software modules can each be implemented on dedicated computing devices. As another example, one or more software modules can be distributed among a plurality of computing devices. It should be appreciated that the computing device can be a physical computing device and/or a virtual computing device.

As can be appreciated, the servers implementing one or more banking engines and/or their software modules are configured to communicate with one another. For example, in the present embodiment, the servers exist in a data communication network. The Internet is an example of a suitable data communication network, although other communication networks are also possible, such as a Local Area Network (LAN), Wide Area Network (WAN), Server Area Network (SAN), Campus Area Network (CAN), etc.

It should be appreciated that in some embodiments, the various services of banking engine 13 can be operated in software containers. As is known to a person skilled in the art, a container is a standard unit of software that packages code and all its dependencies so that an application or service can run easily from one computing environment to another. In the present embodiment, each software module 18 can be provided as part of its own container which also includes required libraries and configuration files. Similarly, the ULM 37 and/or any components thereof (such as ledger 38, interconnect layer 34, front end layer 36, etc.) can also be provided as part of their own containers. Such containers can be run by container management software (i.e. a container platform, such as Docker) that itself runs on an operating system of a computing device. The container management software can provide the required communication link between different containers. As can be appreciated, a group of containers can operate on a set of processors and if a software module within the container fails, the container can easily be removed and a new one started to replace it. If the need for a software module increases, new containers bundling the needed software modules can be easily started. Alternatively, if fewer services are requested (because clients leave a bank or a bank closes), the container management software can kill (remove) containers, thereby optimizing the number of servers and processors required to operate the banking engines 13. In an embodiment, the customer can interact with a custom bank implemented by the banking engine 13 generally in two ways. The first way is a direct interaction through the front-end layer 36 of the banking engine 13. The customer can log-in remotely to the server implementing the banking engine 13 and perform banking transactions via the one or more financial products that are implemented on the particular banking engine 13.

The second way of interaction is a higher level of interaction at which individual financial products that are run on multiple banking engines 13 are exposed and can be accessed and used by the customer. In this fashion the customer can build a suite of financial products to suit his/her needs by choosing in a range of products that are supported by different banking engines 13.

In one specific example, the second way of interaction is implemented through a virtual marketplace 15 allowing each custom bank, such as custom banks A , B and C, to expose individual financial products 12 to customers 14 who can subscribe to them as further described below.

FIG. 7 illustrates a possible form of implementation of the ecosystem 10, shown at the network level to illustrate individual network components. The ecosystem 10 includes a central management server 700 that communicates with individual customers 14 through a customer device 702, such as a mobile device, which can comprise the user interface 802 described above. The server 700 also communicates with servers 704, 706 and 708 that implement respective custom banks A, B and C. Servers 700, 704, 706 and 708 should also be understood to also mean groups of servers that together offer the described services. It is noted that the above is merely an exemplary arrangement, which can vary.

Alternatively, as shown by the dashed communication arrow 710, the customer can communicate directly with any individual custom bank A, B and C to conduct transactions with that custom bank instead of interacting with the server 700 which implements the virtual marketplace, as discussed below. This alternative may be implemented, for example, for a customer having financial products from only one custom bank, in this example custom bank 708.

FIG. 7a illustrates the various components of the server 700. The server 700 has three main components, namely a virtual marketplace software component 800, a banking portal 801, a customer profile database 804 and a communications layer 805.

The structure of the virtual marketplace software component is shown in greater detail in FIG. 7b. The virtual marketplace software component 800 has a customer front end 900, which allows customers to interact with the virtual marketplace. For example, the customer front end 900 will enable a GUI on the mobile 702 of the customer 14 and will provide on that GUI the tools to allow the customer 14 to view financial products available on the virtual marketplace, subscribe or purchase those products, search for products in the virtual marketplace, etc. An example of the GUI on the mobile 702 is shown at FIG. 8.

The customer 14, through the user interface 900, is able to select the financial products 12 suited for his or her needs by, for example, clicking on icons representing each financial product 12. Other non-limiting methods of selection may include swiping icons representing financial products 12 selected by the customer 14 or clicking descriptive text of each financial product 12 selected by the customer 14. In one embodiment, the customer 14 may select two or more financial products 12 among those offered by the same custom bank or in another embodiment the customer may choose two or more financial products from different custom banks. For example, the customer may choose a checking account from custom bank A, a saving account from custom Bank B and a credit card from custom Bank C. In another embodiment, the customer may be offered an incentive to select a predefined bundle of financial products 12 comprising at least two financial products 12. This bundle may combine at least two financial products initially offered by a single custom bank or by different custom banks offered in the virtual marketplace, thereby constituting a custom bundle. For example, a customer may be offered on the marketplace 15 a savings account with a 3% interest rate on balances above $5,000 from custom bank A and a credit card from custom bank B with a $15,000 credit limit. However, if the customer selects both offers (instead of choosing a different credit card or savings account from other custom banks), the customer will obtain a 4% interest rate on balances above $5,000 from custom bank A, instead of a 3% interest rate. The creation and offering of bundles to customer on the marketplace is allowed by the fact that each financial product (savings account from custom bank B and credit card from custom bank C, for example) are enabled by software modules 18 executed on banking engines 13 within the ecosystem 10, as further described below.

In one embodiment, a predefined bundle of financial products 12 may be offered to a customer on the virtual marketplace 15 by a financial services merchant 29 selecting a software module 18 implementing a predefined bundle directly from the software module selection platform 16. This predefined bundle available on the software module selection platform 16 may have been created and uploaded by a software module developer 23 or by at least two financial service merchants as described below. The software module 18 of this predefined bundle of financial products selected by a financial services merchant is integrated to the core layer of a banking engine 13 like other software module 18 as described herein.

In another embodiment, a custom bundle of financial products 12 may be offered to a customer 14 on the virtual marketplace 15 when at least two financial services merchants 29 agree to create a bundle by combining at least two of their financial products 12. The selection by the customer 14 of the financial products 12 included in the bundle on the virtual marketplace 15 may be viewed as condition or an incentive to enjoy the benefits of the bundle. For example, in an effort to share customers 14 using their respective financial products 12, the financial services merchant 29 of custom bank A may agree to augment by 1% the annual interest rate for deposits over $1,000 in Savings account S1 from custom bank A made by customers 14 who also carry a balance of at least $1,000 on the credit card C1 from custom bank B, while the financial services merchant 29 of custom bank B may agree to reduce by 1% the monthly interest rate for the unpaid balance on a credit card C1 from custom bank B for customers who also use the Savings account 51 from custom bank A with deposits over $1,000. This bundle offer may encourage customers of custom banks A and B to use the other custom bank's financial products.

According to the agreement, the at least two financial service merchants 29 may each further customize the software modules 18 implementing their financial products 12 included in the bundle as described herein. In one embodiment, the banking engine 13 and software module 18 of a first custom bank implementing a first financial product 12 included in a custom bundle may comprise logic for a first customization to communicate with the customer profile database 804 through the interconnect layer 34 and the communications layer 805 for confirmation that the conditions of the bundle, such as the selection by the customer of a tied second financial product 12 offered by another custom bank, was made and is recorded in the customer profile in the customer profile database 804. This confirmation may be communicated back to the banking engine 13 of the first bank containing the software module 18 implementing the first financial product 12 and linked to the activation of the second customization which may be the application of the benefit of the bundle to the first financial product 18 over the communication layer 805 and the interconnect layer 34. Conversely, the banking engine 13 and software module 18 of the second bank implementing the second financial product 12 included in a custom bundle may also comprise logic to communicate with the customer profile database 804 through the interconnect layer 34 and the communications layer 805 for confirmation that the conditions of the bundle, such as the selection by the customer 14 of the tied first financial product 12 offered by the first custom bank, was made and is recorded in the customer profile of the customer profile database 804. This confirmation may be communicated back to the banking engine 13 of the second custom bank containing the software module 18 implementing the second financial product 12 and linked to the activation of the second customization which may be the application of the benefit of the bundle to the second financial product 12 over the communication layer 805 and the interconnect layer 34.

For example, the banking engine 13a and software module 18a of custom bank A implementing a savings account S1 included in the bundle described above may comprise a first customization ordering to communicate with the customer profile database 804 on a monthly basis through the communication layer 805 to confirm the first condition that a customer 14 using the savings account S1 having deposits over $1,000 in Saving account S1 is also using the credit card C1 from custom bank B. Once the confirmation for the first condition is communicated back to the software module 18a of custom bank A, a second customization may be enabled and order communication with the banking engine 13b of custom bank B, more precisely with the software module 18c implementing the credit card C1, over the interbank transfer rail 31, to confirm the second condition that the same customer 14 has a balance of at least $1,000 on the credit card C1 from custom bank B. Once the confirmation for the second condition is communicated back to the software module 13a of custom bank A, a third customization may be enabled to order a logic to modify the annual interest initially customized by increasing it by 1%, calculate the total amount of interest owed to the customer 14 and then credit the Savings account of the customer 14 with this total amount of interest.

Conversely, at the end of each month, the same kind of process may be performed by the banking engine 13b and software module 18c of custom bank B implementing the credit card C1 included in the bundle described above. The software module 18c may comprise a first customization ordering communication with the customer profile database 804 on a monthly basis through the communication layer 805 to confirm the first condition that a customer 14 using a credit card C1 from custom bank B having an unpaid is also using the savings account S1 from custom bank A. Once the confirmation for the first condition is communicated back to the software module 18c of custom bank B, a second customization may be enabled and order communication with the banking engine of bank A 13a, more precisely with the software module 18a implementing the savings account S1, over the interbank transfer rail 31, to confirm the second condition that the same customer 14 has deposits of at least $1,000 on the savings account from custom bank A. Once the confirmation for the second condition is communicated back to the software module 18c of custom bank B, a third customization may be enabled to order a logic to modify the monthly interest rate for unpaid balance initially customized by decreasing it by 1%, calculate the total amount of monthly interest due by the customer 14.

These customized software modules included in a custom bundle may be linked, uploaded in the software modules offering platform 16 by the financial services merchants 29 via the financial products upload feature 21 and presented to other financial service merchants as predefined bundles available for selection.

The customer front end 900 comprises a user interface allowing a customer to interact with the various financial products offerings or bundles. Specifically, the customer can search for financial products 12, can see special offers, can see bundles offered by financial services merchants 29 and can also select the desired financial products 12 such that the customer can use them.

An example of the front end 900 implemented as a GUI is shown at FIG. 7D. The GUI is configured with tools allowing the customer to rapidly and conveniently identify the financial products of interest. The example of the GUI 900 includes the following tools:
1. A search function 918. The user can input a string of characters to search the virtual marketplace for financial products of interest. A string such as “savings 2%” for example, would fetch savings account financial products that offer 2% of annual interest rate or more. The search logic is run by the virtual marketplace management layer 906. When the customer interacting with the GUI 900 enters the search string, the string is transmitted to the virtual marketplace management layer 906, the search logic searches the contents of the financial products catalog 904 and returns the results back to the GUI 900 for display to the customer.
2. The categories tool 920 would list the financial products per established categories that are stored in the financial product catalog 904. For example, the financial products can be grouped in categories such as credit cards, mortgages, savings accounts, checking accounts, rewards programs, etc.
3. The discover tool 922 highlights new product offerings in the virtual marketplace. Typically, that would be new product offerings that a financial products merchant would like to showcase. In a specific example of implementation, the virtual marketplace management layer 906, manages the discover tool 922 by dynamically changing the product offerings that the user will see based on certain criteria. For example, the criteria can be the date at which a financial product has been made available to the marketplace, such that new individual product offerings or new bundles will be shown to the user when the “discover” button is clicked. Another possible criteria is ratings collected from customers—products that attract the highest ratings, can become “top picks” and can be listed in the discovery category.
4. Bundles 924 are a category where bundles are shown.
5. The Reviews 926 tool allows customers to make reviews of financial products and also consult the reviews made by other customers that interact with the virtual marketplace. In one form of implementation, the customer is allowed to make a review by providing an overall satisfaction rating, such as 3 stars out of five stars. Optionally, comments can be provided to introduce more details. The ratings, whether number of stars and/or comments are integrated into the file associated with the financial product—in other words, they become part of that file, which is updated every time a customer leaves a review.
6. The Recommendations category 928 relies on the degree of popularity of financial products among users in the ecosystem 10 to make product recommendations on the basis of the use of certain financial products by the customer. The server 700 stores in a customer profile database the list of financial products that each customer uses. The structure and operation of the customer profile database will be discussed in greater detail later.

FIG. 7E shows a component of the customer profile database 804 which lists the financial products that the customer uses. In the case of customer 1, the list includes financial products 1, 5 and 7, etc. When a particular customer subscribes to financial product 1, the virtual marketplace management layer 906 will, on the basis of the other customer profiles rank other most popular products that customers using the financial product 1, use as well. For example, customer 1 also uses financial products 5 and 7. Customer 2 does not use financial product 1 so his or her choices are not considered. Customer 3 uses in addition to financial products 1, financial products 6 and 3. Customer N uses financial products 5 and 7 in addition to financial product 1. Based on that usage pattern, the virtual marketplace management layer 906 will determine the next most popular financial product that customers use in addition to financial product 1. In the above example, that will be financial product 5, since two customers, customer 1, use it and customer N that also use financial product 1. Financial product 7 also falls in the same category since both customer 1 and customer N use it. As for customer 3, who also uses financial product 1, that individual also uses financial products 6 and 3.

Accordingly, the virtual marketplace management layer 906 will rank the recommendations of the financial products to someone subscribing to financial product 1 as follows:
a. First rank recommendations—financial products 5 and 7 (two other uses)
b. Second rank recommendations—financial products 3 and 6 (single user instance).

Referring back to FIG. 7a, the server 700 can also store the customer profile database 804. The structure of that database is shown in greater detail at FIG. 7f. It comprises a customer identifier 940, which allows distinguishing the particular customer from other customers in the database 804. For example, the customer ID can be a combination of user name and password or any other form of authentication mechanism.

The customer profile database also includes preferences 942 holding data that customizes the environment for that particular customer, such as the language of the virtual marketplace, or any other parameter that is customizable to suit the customer preferences.

A list 944 of registered products lists all the financial products to which the customer has subscribed and that are being used. That list is dynamically updated as products are subscribed to through the virtual marketplace. A suitable registration process can be used to update that list. For example, when the user identifies a particular financial product of interest in the virtual marketplace, the registration process is launched. Note that the registration process may require establishing a proper identity of the customer. Banking rules may require that before a financial product is set up for a customer, the financial services merchant 29 needs to positively establish the customer identity. For example, the customer may be required to upload a picture of an official document (passport, drivers license, etc.). Another possible authentication mechanism may rely on an electronic payment cycle as disclosed in the Canadian patent application 3,007,798. Note that once the identity of the customer has been positively established in connection with a particular one of the financial products, that certification may be re-used for further financial products that the customer acquires or subscribes to, even if those products are run on different banking engines 13. In other words once the customer establishes his/her identity positively and there is a secure authentication mechanism that controls access to the customer profile, financial products can be added to the list of registered products and they inherit the established identify credentials.

Finally, the customer profile database 804 includes a list of contacts for the customer, which may be uploaded in any desired fashion.

Although in the present embodiment the customer profile database 804 is illustrated as being part of central server 700, it should be appreciated that in other embodiments, the customer profile database 804 can be implemented on a separate server.

Referring back to FIG. 7A, the server 700 also implements a banking portal 801 which can be integrated into the interface of the virtual marketplace or separate therefrom. As can be appreciated, the banking portal 801 can serve as a gateway allowing customers to interact with the financial products to which they are subscribed, such as performing financial operations, transactions, balance queries, etc. The banking portal 801 can be accessed, for example, through a user interface 802.

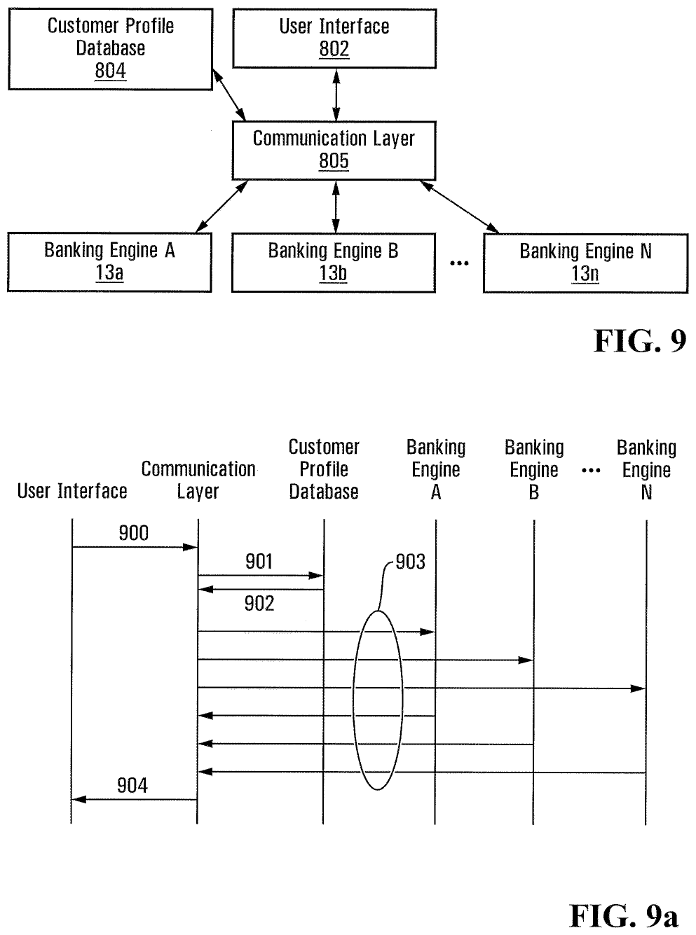

FIG. 9 illustrates the interoperation of the various components of the ecosystem 10 through the interface 802, while FIG. 9A shows the general process flow when a customer performs banking operations.

Note that FIGS. 9 and 9A relate to an arrangement where the customer profile database 804 is separate from the server 700 which implements the user interface 802. In this arrangement the communication between the customer profile database 804 occurs through the communication layer 805.

When a customer 14 wants to interact with the ecosystem 10 to perform banking operations, the customer can first be authenticated on the customer device 702. For example, the user can enter a unique authentication key and/or unique identifier (unique ID) via the user interface on a customer device 702 (step 900). Other methods of authentication can include entering authentication information such as a login and password on the customer user interface 802, thumbprint scan, iris scan, facial recognition on the customer device 702, heartbeat measurement on a wearable device in communication with the customer device702 and any other method known in the art for authenticating a user. The authentication information can be sent to a server hosting the customer profile database 804 (step 901) to match the authentication information with a customer profile. Once a customer profile is matched and the customer has been authenticated, information contained in the customer profile relating to the customer's financial products can be communicated back to the customer device 702 via the communication layer 805 (step 902). Such information can include, for example, a list of financial products 12 to which the customer 14 has subscribed through the virtual marketplace 15. With this information, the customer device 702 can be enabled to communicate with the appropriate banking engines 13 to request relevant information therefrom (step 903). For example, the customer device 702 can send a request via an API protocol to central server 700 for a list of transactions in one of the customer's financial products. Such a request can, for example, include the customer's unique ID. Upon receiving the request, the central server 700 can forward said request to the appropriate banking engine via a corresponding API protocol. To do so, the central server 700 can first, for example, query banking engine database 33 to identify the banking engines hosting the financial products. The banking engine receiving the forwarded request can retrieve the relevant transaction information of each relevant software module (for example via the ULM 37), and return the requested transaction information to the central server 700. Importantly, the banking engine can respond directly to central server 700 without needing any authentication information therefrom; it can assume that access to the requested information is authorized, since authentication was already carried out by central server 700. Thus, once the customer has authenticated himself in step 900, he has access to all software products he has subscribed to, including those of separate custom banks, without the need for further authentication at each custom bank.

As can be appreciated, the customer device 702 can send multiple API requests to the central server 700 for a list of transactions of different financial products to which the customer is subscribed, and each of those requests can be forwarded by the central server 700 to the appropriate banking engine. Alternatively, the customer device 702 can send a single request which includes a request for lists of transactions for multiple financial products. Upon receiving lists of transactions for multiple financial products (which may be received from one or more banking engines), the central server 700 can combine said transactions, and return them to the customer device 702 via an API protocol (step 904). Alternatively, the lists of transactions can be returned separately.

Upon receiving lists of transactions for multiple financial products, software operating on the customer device 702 can then display the transactions from multiple financial products in a combined list in user interface 802. The client may, for example, sort the transactions by date, by alphabetical order, by account (checking or credit card), by bank (A or B) or by amount of transaction, among others. In a similar fashion, the client can perform banking operations by transmitting requests to conduct other operations (such as a transfer of funds) via the API through the central server 700. Although in the above-described example, the customer device 702 obtains transaction information from multiple independent banking engines 13, it should be appreciated that a similar process can apply to retrieve any other type of relevant information from the software modules and/or to interact with the software modules. For example, the customer device 702 can make balance queries, initiate transactions, etc.

As a further example, once a customer is authenticated using the customer user interface 802 on the customer device 702, the customer 14 may see her balance across multiple accounts from multiple custom banks in the user interface 802 on the customer device 702. User interface 802 may display all of her transactions in all accounts (for instance all transactions from a checking account from custom bank A, a savings account from custom bank B and a credit card account from custom bank C). User interface 802 may also offer a selection mechanism whereby the user may see all interactions in all checking accounts (including checking accounts from different custom banks), or all interactions in all savings accounts (including savings accounts from different custom banks) or all interactions in all credit card account (including credit card accounts from different custom banks). In an exemplary operation, the customer 14b may click on an icon in the user interface 802 on her mobile device labelled ‘transactions’. Logic on the mobile device is then configured to display to the customer 14 a selection of account types from which she may select one, for instance ‘cash’, ‘credit’, ‘investment’ or Selection of ‘cash’ will display all transactions from all cash account such as savings and checking accounts. Selection of ‘credit’ will display all transactions from all credit accounts such as lines of credit and credit card accounts. Selection of ‘investment’ will display all transactions from all investment accounts. Selection of ‘all’ will display all transactions. Logic residing on the customer's mobile device may obtain the list of accounts from the customer profile database 804 residing on a server arrangement via the communications layer 805. When the customer 14 selects ‘cash’ for example on the user interface 804, the selection is communicated to the communications layer 805 by the logic. The communications layer 805 then, via a server arrangement, communicates to the banking engines 13a of custom bank A and 13b of custom bank B and requests transactions from the customer's checking account with custom bank A and savings account with custom bank B, respectively. Logic in banking engines 13a of custom bank A and 13b of custom bank B return the requested information to the communications layer 805 via the server arrangement, and the communications layer 805 combines the transactions from checking account of custom bank A and savings account of custom bank B, sorting them by date or other parameter as the customer 14 may request via the user interface 802. Communications layer 805 then communicates the combined list of transactions to the logic of the customer 14 mobile device, which then displays them to the customer 14 on the user interface 802. Similarly, a list of combined transactions may be created for credit or investment accounts, or for all accounts of the customer 14.

Although in the embodiments described above, a central server 700 is provided to act as an intermediary between the customer device 702 and a plurality of servers 704, 706, 708 implementing custom bank engines, it should be appreciated that other configurations are possible. For example, in some embodiments, the customer device 702 can communicate directly with banking engines. Such a configuration can be useful, for example, where the banking engines are implemented as a set of containers.

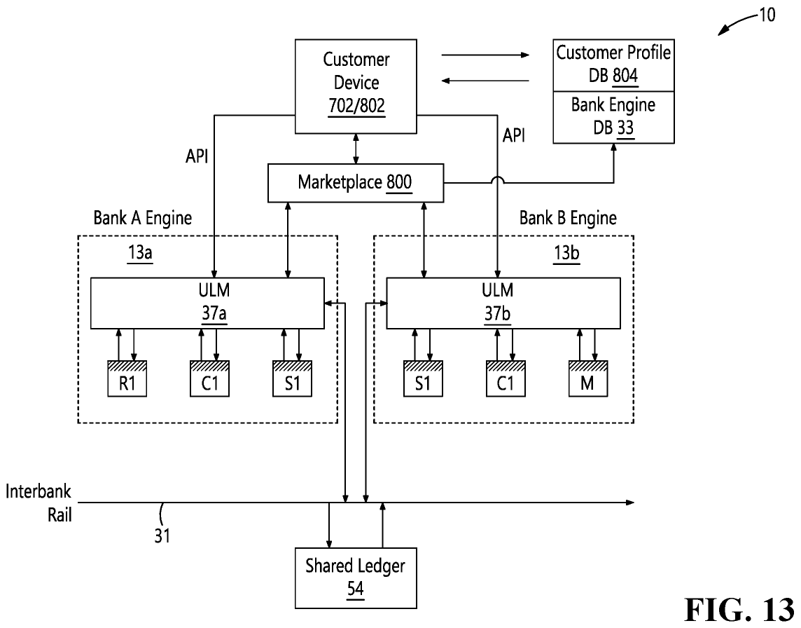

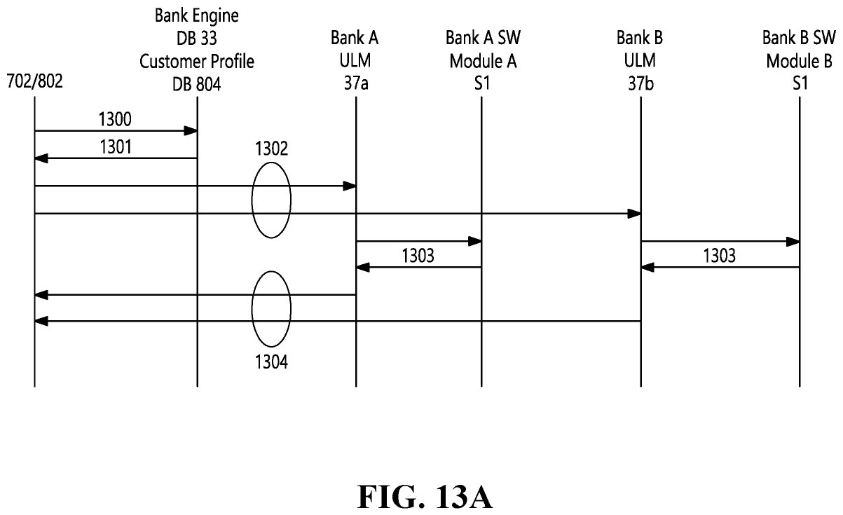

With reference to FIG. 13, an exemplary configuration of ecosystem 10 is shown in which banking engines are implemented as a set of containers. In the illustrated configuration, a customer 14 is interacting with a customer device 702 via a user interface 802, to obtain transaction information from financial products provided by two separate bank engines, namely bank A engine 13a and bank B engine 13b.

With further reference to FIG. 13A, when a customer 14 wants to interact with the ecosystem 10 to perform banking operations, the customer can first be authenticated on the customer device 702. For example, the user can enter a unique authentication key and/or unique identifier (unique ID) via the user interface on a customer device 702 (step 1300). Other methods of authentication can include entering authentication information such as a login and password on the customer user interface 802, thumbprint scan, iris scan, facial recognition on the customer device 702, heartbeat measurement on a wearable device in communication with the customer device 702 and any other method known in the art for authenticating a user. The authentication information can be sent to a server hosting the customer profile database 804 to match the authentication information with a customer profile. Once a customer profile is matched and the customer has been authenticated, information contained in the customer profile relating to the customer's financial products can be obtained, such as a list of banks and accounts. In step 1301, the list of accounts can be returned to the customer device 702. As can be appreciated, the list of accounts can include address information for communicating with each bank engine hosting the software modules which implement each account. In some embodiment, the address information can be obtained by querying banking engine database 33. In some embodiments, the banking engine database 33 can be combined with the customer profile database 804 discussed below.

In step 1302, upon receiving the list of accounts, the customer device 702 can communicate with the ULM 37 of each relevant bank engine 13 using the address information provided in the list of accounts. For example, in the present embodiment, the customer device 702 sends a first request via an API protocol to the ULM 37a of banking engine A 13a, requesting a list of transactions in savings account S1. Similarly, the customer device 702 sends a second request via an API protocol to the ULM 37b of banking engine B 13b, requesting a list of transactions in checking account C1.

In step 1303, the ULM 37a of banking engine A 13a communicates with the container implementing savings account S1 to request the list of transactions, which are then provided to the ULM 37a. Similarly, the ULM 37b of banking engine B 13b communicates with the container implementing checking account C1 to request the list of transactions, which are then provided to the ULM 37b.

In step 1304, the ULMs 37a and 37b return the list of transactions that they obtained to the customer device 702 via the API protocol. Software operating on the customer device 702 can then display the lists of transactions in a combined manner in the user interface 802. As can be appreciated, the transactions can be displayed and the customer can interact with the banking engines 13a, 13b in a similar manner as was described in connection with the configuration with a central server 700.

Importantly, the banking engine can respond to requests from the customer device 702 without additional authentication. Indeed, the banking engine can assume that access to the requested information is authorized, since authentication was already carried out on the customer device 702. Thus, once the customer has authenticated himself in step 1300, he has access to all software products he has subscribed to, including those of separate custom banks, without the need for further authentication at each custom bank.

It should also be appreciated that in the configuration of FIG. 13, the customer device 702 can also communicate directly with a marketplace 800. In the illustrated configuration, the marketplace can operate in containers on a dedicated server or set of servers. As described above, the marketplace 800 can allow financial services merchants to provide their financial products to clients, and allow clients to select/subscribe to desired financial products amongst those that are offered. For instance, Bank A′s savings account S1 can be made available to the client in the marketplace, as well as Bank B′s checking account C1. As such the customer device 702 can send a request to the marketplace via an API protocol, requesting a list of available financial products and may choose one or more that will subsequently be available as part of the customer's profile. Once the customer has chosen a financial product, the customer's choice of financial product can be registered in the customer profile database 804 in association with his ID. The functionality of the chosen financial product can then be made available to the customer via customer device 702, and communication with the financial product's software modules can be carried out as described above through an API call to the appropriate banking engine's ULM.

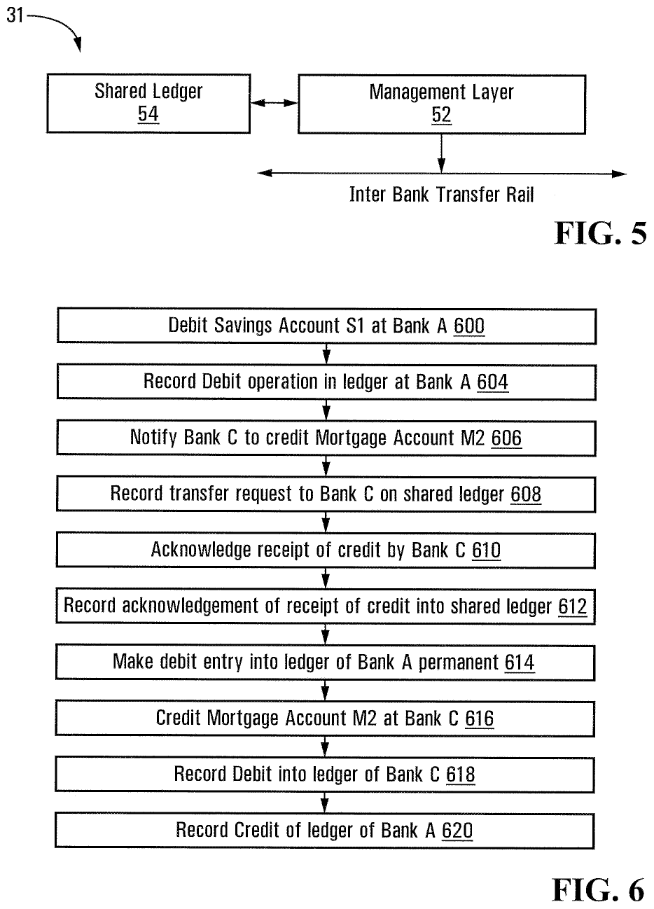

Referring back to FIG. 1, custom banks A, bank B and bank C, which have all been created with the bank generation platform 11 are all connected to the inter-bank transfer rail 31 allowing financial transactions to be made between the individual custom banks A, B, C without the need to involve a payment processor. The inter-bank transfer rail 31 is shown in greater detail in FIG. 5. It comprises a management layer 52 which directs payments and messages between individual bank engines 13 and a shared ledger 54 which is a database recording transactions, as described in greater detail below. The banking engines 13 implementing custom banks A, B and C connect to the management layer 52 via their respective interconnect layers 34. The shared ledger 54 communicates with the management layer 52 to record financial transactions performed between banking engines 13 implementing custom banks connected to the inter-bank transfer rail 31.

FIG. 6 is a flowchart that illustrates an example of operation of the inter-bank transfer rail 31. For example, consider the scenario where a customer 14 has opened the savings account 12a at custom bank A and also has opened a mortgage account 12d at custom bank C via the virtual market place 15. The customer 14 wants to credit the mortgage account 12d by transferring $1000 from the savings account 12a at custom bank A. At step 600 the customer directs custom bank A to debit the savings account 12a by $1000 and identifies the destination account to be credited, which is the mortgage account 12d at custom bank C. At step 604, the debit operation is recorded at the ledger 38 of the banking engine 13a implementing custom bank A. At step 606, the interconnect layer 34 of the banking engine 13a implementing custom bank A communicates with the management layer 52 of the inter-bank transfer rail 31 to notify the banking engine 13c implementing custom bank C, via its interconnect layer 34 to credit the mortgage account 12d. The request to transfer funds to the mortgage account 12d is recorded into the shared ledger 54 at step 608. At step 610, the banking engine 13c implementing custom bank C, through its interconnect layer 34 sends an acknowledgement to the management layer 52 of the inter-bank transfer rail 31 of the receipt of the credit request. That notification is sent over the inter-bank transfer rail 31 and communicated to the banking engine 13a implementing custom bank A. At step 612 that notification is recorded into the shared ledger 54, which now shows that a request to credit the mortgage account 12d of custom bank C has been made by custom bank A and an acknowledgement of receiving the credit has been made by custom bank C.

In other words, the shared ledger 54 keeps track of the transactions occurring between the custom banks A, B and C. At step 614, the acknowledgement of receipt of the credit is processed by the integration layer 32 of the banking engine 13a implementing bank A and the operation is recorded into the ledger 38 of the banking engine 13a implementing custom bank A, which essentially marks the initial debit entry on the savings account 12a as valid. At step 616 the mortgage account 12d is credited and at step 618 the entry is recorded into the ledger 38 of the banking engine 13c implementing custom bank C. Finally, at step 620, the credit operation may be recorded at the ledger 38 of the banking engine 13a implementing custom bank A.

As can be appreciated, the transfer of funds between custom banks can be initiated by a customer device 702, for example via its user interface 802. Once a user has been authenticated as described above, the interface 802 can be used to send a request to a software module to which the customer is subscribed in order to initiate a transfer to software module hosted by another banking engine part of the ecosystem 10. Following a transfer of funds, the customer device 702 can request financial information from the software modules according to the procedures described above in connection with FIGS. 9A and 13A, for example to display an updated balance of each software module on the user interface 802, and/or to display an updated list of transactions.

In the embodiment illustrated in FIG. 13, containerized software modules communicate through the ULM 37 to carry out transactions over the inter-bank transfer rail 31. As described above, the ULM 37 can comprise the private ledger 38 and the interconnect layer 34. Accordingly, transactions between software modules implemented as containers can be carried out in the same fashion as described in FIG. 6. Although the ULM 37 is illustrated as a single software container, it should be appreciated that private ledger 38 and/or interconnect layer 34 can each be provided as separate software containers which communicate with ULM 37 to perform their functions.

It should further be appreciated that in some embodiments, instead of having a dedicated interconnect module 34 for communicating over the inter-bank rail 31, each of the containerized software modules can communicate directly with the rail 31. For example, if a customer wants to transfer an amount from savings account S1 of bank A 13a to checking account C1 of bank B 13b, the savings account container S1 can send a message directly to checking account container C1 over the inter-bank rail 31. The savings account container S1 can further notify ULM 37a of the debit transaction for recording in the private ledger 38 (which can be part of ULM 37a, or in a separate container). Similarly, the checking account container C1 can notify ULM 37b of the credit for recording in its private ledger 38 (again, which can be part of ULM37b, or in a separate container).

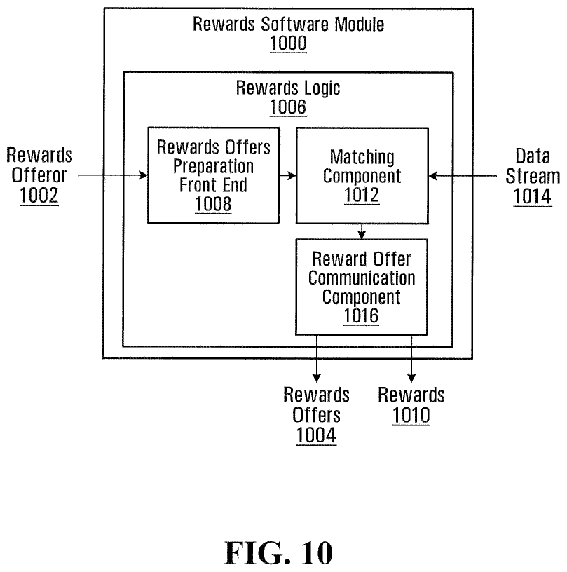

FIG. 10 is a diagram of a rewards software module 1000, which can be provided in the software module offering platform 16, selected by a financial service merchant 29, offered on the virtual marketplace 15, used by a reward offeror 1002, which may be a business customer 14, to prepare reward offers 1004 that will be presented to customers 14 based on the satisfaction of specific conditions, such as, but not limited to, specific banking operations within the ecosystem 10.

The rewards software module 1000 uses a rewards logic 1006 comprising a reward offer preparation front end 1008 to allow a reward offeror 1002 that has selected the rewards financial product to prepare conditions necessary for the attribution of a reward 1010 linked to an offer to a customer 1004.

The rewards logic 1006 may also comprise a matching component 1012 that receives and stores offers prepared by reward offerors 1002 in a reward offer file that comprises reward offer information such as the conditions necessary for the presentation of an offer to a customer, conditions necessary for the attribution of a reward linked to an offer, the nature or the amount of the reward, the identity of the reward offeror 1002 and the financial product 12 of the reward offeror containing funds for the attribution of the reward 1010. The matching component 1012 also receives a stream of data 1014, that may comprise banking operations data of a customer 14 that has selected the rewards financial product 12 on the marketplace 15. The customer stream of data 1014 may come from banking operations made with any of the financial products 12 that she selected on the virtual marketplace 15, as explained above, and those financial products 12 may be implemented by different software modules 18 executed on different banking engines 13. Thus, the stream of banking operations data 1014 may be conveyed from software modules 18 executed on different banking engines 13 to the matching component 1012 through the interbank transfer rail 31. Once received by the matching component 1012, data from the stream of data 1014 is processed by logic in the matching component 1012 for comparisons with the reward offer conditions to verify if the reward offer conditions are satisfied and identify rewards 1004 that the customer 14 may be entitled to and then present them to the customer 14.

The rewards software module 18 may also comprise a reward offer communication component 1016. The reward offers communication component 1016 may be configured to notify a customer 14 which satisfies the offer presentation conditions based on her stream of data 1014 that she could benefit from a reward 1010 if she satisfies the conditions necessary for the attribution of a reward 1010. In one embodiment, there may be no offer presentation conditions prepared by the reward offeror 1002 so that any customer using the rewards financial product would be notified of the offer 1004. The reward offers communication component 1016 may also be configured to notify a customer 14 who satisfies the reward attribution conditions that she is entitled to receive a reward 1010 and that a reward has already been applied. In one embodiment, the reward offers communication component 1016 communicates notifications that may appear on the user interface 802 at which the customer carries out banking operations with the financial products supported by multiple banking engines 13 of the ecosystem 10.

Rewards offer 1004 may be any offer for a monetary reward 1010 such as a rebate for the purchase of a certain product or service, when certain conditions are met. For example, the reward from a rewards offeror 1002 may be a $5.00 rebate for a purchase at Fred's pizza when a minimum of $30.00 of gas is purchased at Joe's garage which is located near Fred's pizza. Alternatively, the reward 1010 could be for a product offered at Joe's garage. In one scenario for this example, there may be no condition for the presentation of the reward offer 1004 to the customer so that any customer using the rewards financial product could receive a notification from the reward offer communication component 1016. In another scenario, the condition for the presentation of the reward offer 1004 to the customer may be a first purchase of a minimum of $30.00 of gas at Joe's garage. When the matching component 1016 of the rewards logic 1006 identifies the purchase of a minimum of $30.00 for gas at Joe's garage, the communication component 1016 sends a notification presenting the reward offer 1004 that may inform the customer 14 of the remaining conditions for the attribution of the reward 1010, in this example a second purchase at Fred's restaurant. In both scenarios, the conditions to obtain the reward 1010 are a first purchase of a minimum of $30.00 for gas at Joe's garage and a second purchase at Fred's pizza.

When the matching component of the rewards logic 1006 identifies the first purchase, namely a minimum of $30.00 for gas at Joe's garage, and the second purchase, namely a purchase at Fred's restaurant, from the banking operations data stream 1014 of the customer 14, it outputs a customer reward 1004, namely the $5.00 rebate, to the customer 14 . In greater details, the customer may complete the first purchase of $30.00 of gas at Joe's garage by using any financial product 12 selected at the virtual marketplace 15, such as her Checking account from custom bank A or her credit card from custom bank B, among others. The information related to this first banking operation executed by the software module 18 implementing the selected financial product 12 enters the data stream 1014 which is communicated to the matching component 1012 of the rewards logic through the interbank transfer rail 31 which allows communication of information related to banking operations between banking engines 13. Once the information related to this first banking operation is received by the matching component 1012, the satisfaction of the first condition for the attribution of the reward is labeled as satisfied and the customer may be notified of the offer by the communication component 1016.

In response to the notification of the reward offer 1004, the customer may visit Fred's pizza to benefit from the reward 1010, and therefore may complete the second purchase by using any financial product 12 selected at the virtual marketplace 15, such as her Checking account from custom bank A or her credit card from custom bank B. In one embodiment, the customer 14 uses a different financial product 12 than the financial product 12 used for the first purchase. In another embodiment, the customer uses a financial product 12 implement by a software module 18 executed by a banking engine 13 different from the banking engine 13 executing the software module 18 implementing the financial product 12 used for the first purchase. The information related to this second banking operation executed by the software module 18 implementing the selected financial product enters the data stream 1014 which is communicated to the matching component 1012 of the rewards logic 1006 through the interbank transfer rail 31 which allows communication of information related to banking operations between banking engines 13. Once the information related to this second banking operation is received by the matching component 1012, the satisfaction of the second condition for the attribution of the reward 1010 is labeled as satisfied and the customer 14 may be notified of the attribution of the reward 1010 by the communication component 1016.

The attribution of the reward 1010 to the customer 14 may be performed by the matching component 1012 of the reward logic 1006 by applying rules for the attribution of the reward contained in the reward offer information and then by crediting the value of the reward 1010 to the customer 14 through the interbank transfer rail 31. In this example, the matching component 1012 may manage the transfer of the amount associated with the reward 1010 from the software module 18 containing the funds for the attribution of the $5.00 rebate that was designated by the reward offeror 1002 in the reward offer information to any software module 18 implementing the customer's financial product 12 used for performing banking operations that satisfied the attribution conditions. In one embodiment, the customer 14 may decide which financial product 12 will receive the rewards 1010.

In one embodiment, both the customer 14 and the reward offeror 1002 from which the amount associated to the reward 1010 is debited are customers 14 operating through the ecosystem 10. The transfer of the amount associated to the reward 1010 is performed like any other transfer performed through the interbank transfer rail 31, or through the integration layer 32, as described herein. In another embodiment, the reward offeror 1002 is not operating through the ecosystem 10 like the customer 14, therefore the transfer of the amount associated to the reward 1010 is transferred through traditional payment processors.

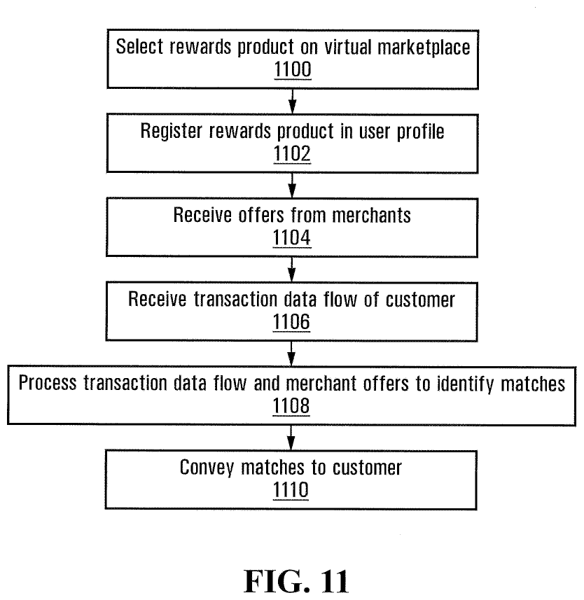

FIG. 11 is a generalized flowchart that illustrates the process for subscribing and then using a rewards financial product. At step 1100, the customer 14 accesses the virtual marketplace 15 and identifies a rewards financial product 12 of interest. The customer 14 then purchases or acquires the rewards financial product, which may involve payment to the financial service merchant 29 offering the rewards financial product 12. The subscription or acquisition of the rewards financial product 12 involves a product registration process at step 1102 where the list of financial products to which the customer has subscribed in the customer profile database is updated to indicate that the rewards financial product is being used by that particular customer.

At step 1104, the software module implementing the rewards financial product, which is now active, receives rewards offers from rewards offerors on the one hand and also receives at step 1106 the data stream of banking operations performed over the entire range of the financial products that the particular customer uses for conducting banking operations. At step 1108, the rewards logic of the rewards software module 1006 tries to identify in the transaction data flow, either individual transactions or combinations of transactions that satisfies the reward offers conditions and make the customer eligible to receive a reward from the reward offerors that are input at step 1104.

If eligible transactions are identified, the corresponding rewards 1010 are then communicated to the customer at step 1110. The rewards can be communicated to the customer either via the user interface 802 that the customer uses to make banking operations in the ecosystem, or via separate messaging, such as by sending text messages or other notifications to the customer.

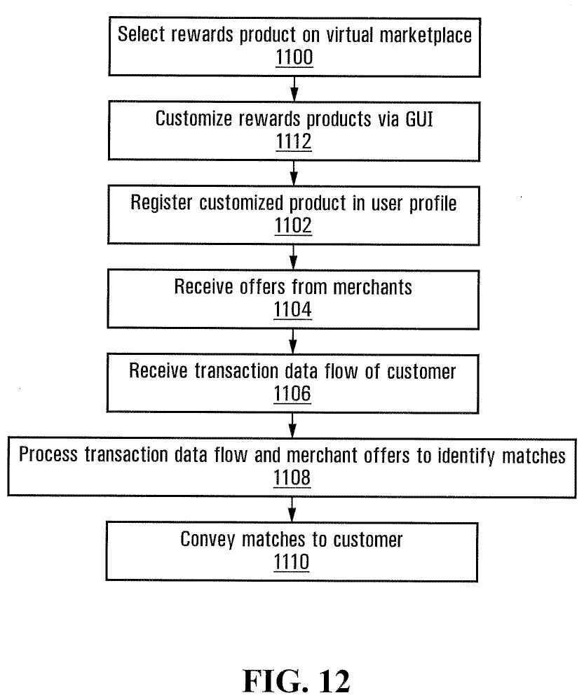

FIG. 12 is a flowchart of the process described earlier, but according to a variant. Steps that are identical or similar to those in FIG. 11 bear the same reference numerals. The key distinction with the previous flowchart is step 1112, which enables the customer to customize the rewards program according to his/her specific needs.

The customization is performed through a GUI implemented by the rewards software module 18. When the customer acquires the rewards financial product, and as part of the registration process, the customization code from the software module is launched and presents the customer with a range of options that can be changed in order to align the output of the rewards financial products with the needs of the customer. Examples of settable parameters include:
1. The range or class of products or services that will be eligible for rewards. For example, the user may prefer to receive rewards only from a limited number of purchase types, for instance gasoline. If the user is a large purchaser of gasoline, it may make sense to focus the rewards only to that class of products in the banking operations data stream from the customer instead of considering other product classes as well. Conversely, the customer may want to eliminate from consideration certain product classes because he or she will never purchase those products. Accordingly, the user interface 80 may be configured to present the customer with a list of product classes, where the customer selects one or more product classes for consideration by the rewards logic for possible rewards. Alternatively, the user interface can be configured to offer product bundles for consideration for rewards, instead of individual choices.
2. The financial products that the customer uses that will be used as the source for the banking operation data stream considered for rewards. Some customers prefer to receive rewards on banking operations they conduct over the entire range of financial products they use. On the other hand, some customers may want to limit rewards to banking operations performed with specific financial products. For instance, a customer may be using a savings account and a checking account, both running on different banking engines 13. The customer is presented with a choice about which accounts should be considered for eligible banking operations. The selection mechanism on the user interface may include a list of the financial products that the customer uses, which is fetched from the customer profile database. Accordingly, the customer sees the active list of financial products he/she uses and can select all or only a subset of those products. In a possible variant, logic can be applied to prevent the customer from selecting financial products that are incompatible with the rewards product. For example, if the rewards product only applies to purchases made in US dollars, then accounts that operate in any other currency do not apply. Hence the validation logic would examine that parameters of the account and remove from the available choices those that are not compatible.

After the customer has completed the customization process, the customized rewards product is stored. In particular, a customization file is created, which specifies the various parameters and the respective settings for the customer and that file is stored in the customer profile database and may be communicated to the reward logic 1000.

In a possible variant, instead of running the rewards logic 1000 on an individual customer basis, it can be run over groups of customers. In a specific example, the transactions of two customers identified as contacts with each other are processed to determine attribution of rewards.

In this example, the system is thus designed to operate on groups of customers 14. The rewards logic 1006 receives from the customer profile database identifiers of the particular customer to be included in the rewards offers determination. For instance, individual members of a family may be individual customers 14 in the ecosystem 10 and subscribe and use their own financial products, but for the purposes of rewards, they may want to pool their purchases together to maximize the rewards. In such instance, the software module implementing the rewards financial product is customized, generally as described earlier by also identifying additional customers from which the banking operations date stream are to be included and considered for rewards. In such instance, the customization process also includes an identification of a particular customer in the group that is to receive the rewards on behalf the entire group. During the rewards determination process, the rewards logic 1006 instead of receiving the banking operation data stream from single customer will receive the banking operation data stream from two or more customers to determine the applicability of rewards. In such example, the customization process of the rewards logic 1006 may also include identification of the particular customer in the group that is to receive the reward on behalf of the entire group.

A customer may select a budgeting financial product from the marketplace. Budgeting financial products may offer services such as, without limitation, tracking income and expenses by category and on a daily, weekly, monthly, quarterly, or annual basis, identifying opportunities to save money or increase income or revenue, identifying special offers made by merchants that may be of interest to customers, and forecasting cashflow. For a customer who has selected a budgeting financial product, the user interface 802 may offer additional functionalities as described below. For example, the budgeting financial product may monitor the total balance of the customer (for example, the sum of all checking, investment and savings accounts minus all short term loans and credit card balances) and if the customer appears to consistently have an excessive positive balance, the budgeting financial product may suggest investing the excess balance in an investment financial product offered by a custom bank, such as a cash certificate, government investment certificate, or other investment product. If the customer confirms her interest in such products, the user interface may then show various appropriate financial products from multiple custom banks in the marketplace, from which she can choose one or more and determine the amount to invest in each. Information from such new financial products would then be integrated into the information shown on the customer's user interface 802, including balance, list of transactions, list of accounts, etc.

As can be appreciated, the software module implementing the budgeting financial product can interact with software modules implementing other financial products to gather and analyze relevant financial information. For example, a software module implementing a checking, savings, or credit card financial product can be operated to retrieve transaction information and send a request to a server implementing the budgeting software module to analyze the transaction information. The budgeting software module can then be operated to analyze the transaction information to identify a financial need of the customer and identify one or more financial products which address the financial need of the customer. The server implementing the budgeting software can subsequently provide recommendation to the customer, for example in the form of a reference to the one or more identified financial products which address the financial need.

In another example, the customer who has selected a budgeting financial product and who is paying excessive credit card fees or interest on her credit card balance may be shown on the user interface 802 an offer of a more competitive credit card near where her total credit card balance is displayed. Such offer may inform the customer of the total amount of fees and interest she has paid in a recent time period (for example the last six months) and inform her it could be reduced by switching credit cards. If she indicates an interest in a different credit card, she would be presented with the customer front end 900 and its GUI showing her competing credit card financial products available in the marketplace with better interest rates or lower fees. She could then select one and add it to her selected financial products and transfer a chosen balance from the first credit card financial product to her new credit card financial product. The new credit card financial product would then be integrated into the information shown on the user interface 802, including her balance, list of transactions, list of her accounts, etc.

In another example, a customer (or business customer) who has created a cash flow budget (including for example projected spending and income in various categories for each month) may be presented with a budget update on user interface 802. For example, the budget update may show that the customer is $500 over budget for the month, meaning she has spent $500 more than budgeted to date. The customer who has selected such budgeting financial product may have a notice shown near the budget update showing the customer that she could save money by shopping at a different store, for example. For example, she may shop regularly at store X for groceries, but the notice may ask if she wishes to save $100 per month by shopping at store Y. If she accepts, she may be presented with a further notice offering her a 10% discount on her first purchase at store Y. Such offer may be implemented by means of a reward financial product described herein.

User interface 802 may be provided for the customer 14 to monitor and interact with her selected financial products 14a, 14b, and 14c in the example of FIG. 1. User interface 80 may contain functionality or tools enabling banking operations such as transfers, payments, account balances, rewards, foreign currencies, and viewing transactions from any accounts. For example, a customer 14 may transfer funds from her checking account in custom bank A to her savings account in custom bank B via the user interface 802, or a further user interface accessed via a link from the second user interface. In this exemplary operation, the customer may click on an icon in the user interface 802 on her mobile device labelled ‘transfers’. Logic on the mobile device is then configured to display to the customer 14 a selection of accounts from which she may transfer money from and to and an amount of money to transfer. The logic may obtain the list of accounts from the customer profile database 804 residing on a server arrangement via the communications layer 805. In another exemplary operation, the customer may be presented via a user interface 802 icons for the various accounts available to the customer (in this example, her checking account with custom bank A and her savings account with custom bank B). The customer may place her finger on the icon of one account and swipe it towards a second account. Logic on the customer's mobile device is configured to identify the initial position of the finger, the movement of the finger across the screen and the final position of the finger. In this example, the logic is configured to identify the checking account in custom bank A as the originating account due to her initial placement of her finger on the icon of her checking account, savings account in custom bank B as the destination account due to her final placement of her finger on the icon of savings account from custom bank B, and that the customer wishes to transfer funds from checking account to savings account due to her swiping from one icon to the other. Logic may then display via the user interface 802 query where customer may choose the amount to be transferred.

The customer's selection of her checking account in custom bank A as the originating account, her savings account in custom Bank B as the destination account and $500 as the amount, via either embodiment described above, is then communicated to the communications layer 805 via the user interface 802. The communications layer 805 then, via a server arrangement, communicates to the banking engine of custom bank A 13a and request that $500 be withdrawn from the customer's checking account and sent to the customer's savings account in custom bank B. The transfer of funds the follows a process similar to that described in FIG. 6 herein.

Payments

In this exemplary operation, a customer may make a payment from her checking account in custom bank A to a company from which she has contracted services. The customer may click on an icon in the user interface 802 on her mobile device labelled ‘payments’. Logic on the mobile device is then configured to display to the customer 14 a choice of payment financial products she has previously selected in the marketplace 15 via the user interface 900. Certain payment products may offer advantages over others, such as speed of payment, fees, or currencies. The customer may then select a payment financial product to use, for this example a payment financial product from Bank D, whereupon the user interface, via logic on the customer's mobile device, will display to the customer a selection of accounts from which she may make a payment an amount of money to pay and a list of previous payment recipients paid by the customer. The logic may obtain the list of accounts from the customer profile database 804 residing on a server arrangement via the communications layer 805. The logic may obtain the list of previous payment recipients from custom bank D's banking engine via the communications layer 805 or alternatively the list of previous payment recipients may be stored in the customer profile database 804 and the logic may obtain the list via the communications layer 805. The customer's selection of her checking account in custom Bank A as the account from which the payment should originate, and $100 as the amount to pay is then communicated to the communications layer 805 via the user interface 802. The communications layer 805 then, via a server arrangement, communicates to the banking engine of custom bank D, specifically, to request that custom bank D's banking engine make a payment to the chosen payment recipient of $100 immediately. As can be appreciated, the recipient can be an external financial institution which is not part of the ecosystem 10. Accordingly, custom bank D's banking engine, upon receipt of the request can makes such payment via its chosen payment system (for example interact, SWIFT, etc.) using logic contained in the payment software module custom bank D's financial merchant chose for custom bank D, as described elsewhere herein.

As described above, the software module implementing the payment financial product can carry out transfers from financial products offered by banking engines in the ecosystem 10 to financial institutions which are external to ecosystem 10 and that are thus not connected via inter-bank transfer rail. To carry out the transfers, the payment financial product can interact with software modules implementing other financial products to source funds which are eventually transferred via an external payment system (such as interact, SWIFT, etc.) For example, a user can transmit a request to the payment financial product which includes an amount, a source account, a specified payment system, and a destination account. The payment financial product can then transmit a request to the software module implementing the source account to debit the amount to be transferred. Following confirmation of the debit from the source account (for example via the intern-bank transfer rail), the software module implementing the payment financial product can be operated to transfer the amount to the external destination account via the specified payment system (which is an external transfer mechanism that is not the inter-bank transfer rail). Once the external transfer is complete, the payment financial product can confirm said transfer to the customer.

Currency Conversion

As a further example, a financial services merchant may create a custom bank, in this example labelled custom bank E, to provide currency conversion services to customers. For example, custom bank E contains a software module with logic that enables conversion between currencies of Canadian dollars to Euros and a checking account software module with the necessary logic to operate a checking account. Custom bank E's financial services merchant has also selected the parameters associated with the currency conversion and checking software modules, such as without limitation interest rates, conversion fees, and conversion rates and he has made available in the marketplace 15 a bundle consisting of its checking account financial product and its currency conversion financial product. A customer 14 has selected the bundle in the marketplace 15. As an example, a customer travelling from Canada to Europe may click on an icon in the user interface 802 on her mobile device labelled, in this example, ‘currency’. Logic on the mobile device is then configured to display to the customer 14 on the user interface 802 a selection of most commonly used currencies, in one example in the form of flags of the countries, and a list of accounts holding funds she may convert to another currency (for instance a checking account in custom bank A and a savings account in custom bank B) and an amount to be converted. The logic may obtain the list of accounts from the customer profile database 804 residing on a server arrangement via the communications layer 805. The logic may obtain via the communications layer 805 the list of flags from the business engine of custom bank E, specifically logic therein which may periodically update the list of most used currencies depending on recent demand, the list stored in a database on a server arrangement. The customer may select, in the user interface 802, the flag of the European Union and checking account from Bank A and an amount of CDN$1,500 to convert. The customer may then be presented with a conversion rate from Canadian dollars to Euros and fees, such conversion rate and fees obtained via the communications layer 805 from the business engine of custom bank E and the customer may agree to such terms by clicking on an icon indicating her agreement. The customer's selection of her checking account in custom bank A as the funding account, the European Union flag and CDN$1,500 as the amount is then communicated to the communications layer 805 via the user interface 802. The communications layer 805 then, via a server arrangement, communicates to the banking engine of custom bank D and request that $1,500 be withdrawn from the customer's checking account in custom bank A, converted from Canadian dollars to Euros and deposited in a checking account in custom bank D. The transfer of funds the follows a process similar to that described in FIG. 6 herein. When the funds are received at custom bank D, logic in custom bank D's banking engine subtracts any agreed fees, converts remaining Canadian dollars to Euros at the agreed rate, and deposits the remainder in the customer's Euro checking account in custom bank D. The Euro checking account in custom bank D is then available to the customer on the user interface 802 for use while in Europe for example, to transfer funds, make payments and obtain cash.

A user interface 802 is described herein through which a customer may interact with the ecosystem 10 and her selected financial products and financial accounts. Readers will understand that the user interface may be composed of a single user interface, or a series of linked user interface, whereby clicking on a link on the first user interface causes logic to create and display a second user interface containing new information related to the link. Furthermore, where a user is presented as means of interaction with an icon to click, readers will understand that the clickable icon is an example of an interaction and that other methods of user interaction are possible, including providing voice instructions which logic may transform into instructions equivalent to clicking on a link, selection of an option from a pull down menu, and other commonly known interaction methods in user interfaces.

Furthermore, customers may interact with the ecosystem via logic through API's. For example, a commercial customer may engage in frequent trading, withdrawing and depositing funds into a commercial checking account of a custom bank. Logic on a customer server may call an API requesting a list of transactions or a balance of the commercial checking account, in a similar manner that an individual customer may do so through the user interface 802. Such API calls may be addressed to the communications layer 805 or the front end layers 36 of the business engines 13. It will be understood by readers that such API calls may replace customer interactions described herein via the user interface 802.

Banks generated in the ecosystem 10 by the generating platform are generally referred to herein as ‘custom banks’ to distinguish them from traditional banks that operate outside the ecosystem. Reference to custom bank A or custom bank B therefore describes a bank generated in the ecosystem 10 by the banking engine generator 11 and connected to other custom banks by the interbank rail.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

To facilitate the description, any reference numeral designating an element in one figure designates the same element if used in any other figures. In describing the embodiments, specific terminology has been resorted to for the sake of description, but this is not intended to be limited to the specific terms so selected, and it is understood that each specific term comprises all equivalents.

In case of any discrepancy, inconsistency, or other difference between terms used herein and terms used in any document incorporated by reference herein, meanings of the terms used herein are to prevail and be used.

Although various embodiments have been illustrated, this was purposes of describing, but should not be limiting. Various modifications will become apparent to those skilled in the art.

1. A computer-implemented method for transferring funds between first and second financial products, the first financial product being implemented by a first software module in a first custom bank engine operated by a first financial services merchant, and the second financial product being implemented by a second software module in a second custom bank engine operated by a second financial services merchant, the method comprising:
transmitting, from a customer device, a request to transfer funds from the first financial product to the second financial product;
receiving the request by a first server implementing the first custom bank engine and, responsive to said request, operating the first software module to debit the first financial product and recording the debit in a first private ledger associated with the first custom bank;
transmitting, by the first server via an inter-bank transfer rail, a request to credit the second financial product,
receiving, by a second server implementing the second custom bank engine, via the inter-bank transfer rail, the request to credit the second financial product;
operating the second software module to credit the second financial product, and recording the credit in a second private ledger associated with the second custom bank engine;
recording the debit from the first financial product and the credit to the second financial product in a shared ledger on the inter-bank transfer rail;
transmitting, from the first server to the customer device, an updated balance of the first financial product;
transmitting, from the second server to the customer device, an updated balance of the second financial product; and
displaying the updated balance of the first financial product and the updated balance of the second financial product on a common graphical user interface (GUI) of the customer device.

2. The method according to claim 1, comprising a preliminary step of authenticating a customer on the customer device and, if the customer is authorized to interact with the first and second financial products, allowing the customer device to transmit the request to transfer funds and receive the update balance of the first and second financial products without further authentication.

3. The method according to claim 2, wherein authenticating the customer comprises retrieving a profile associated with the customer from a customer profile database, said customer profile containing a list of financial products with which the customer is authorized to interact.

4. The method according to claim 2, wherein allowing the customer device to transmit the request comprises providing the customer device with address information for contacting the first server and second server.

5. The method according to claim 2, wherein authenticating the customer comprises transmitting authentication information to a management server and, if the customer is authorized to interact with the first and second financial products, the management server forwards the request to transfer funds from the customer device to the first server, and forwards the updated balance information from the first and second servers to the customer device, further wherein the first and second servers are configured to communicate with the management server without customer authentication.

6. The method according to claim 1, comprising:
transmitting, from the customer device, a request for transaction information corresponding to the first and second financial products;
receiving the request on the first server and, responsive thereto, retrieving transaction information corresponding to the first financial product from the first software module;
receiving the request on the second server and, responsive thereto, retrieving transaction information corresponding to the second financial product from the second software module;
receiving the transaction information corresponding to the first and second financial products on the customer device; and
causing at least some of the received transaction information corresponding to the first and second products to be combined and displayed simultaneously on the GUI.

7. An electronic banking system allowing transfers between first and second financial products, the first and a second financial products being operated by independent custom bank engines, the electronic banking system comprising:
a first server implementing a first custom bank engine, said first custom bank engine being operated by a first financial services merchant and comprising a first software module comprising computer code executable to implement the first financial product, and a first private ledger for recording transactions to and from the first financial product;
a second server implementing a second custom bank engine, said second custom bank engine being operated by a second financial services merchant and comprising a second software module comprising computer code executable to implement the second financial product, and a second private ledger for recording transactions to and from the second financial product; and
an inter-bank transfer rail operatively connecting the first server and the second server and allowing the first custom bank engine and the second custom bank engine to inter-communicate, the inter-bank transfer rail comprising a shared ledger for recording a request from one of the first or second servers to transfer funds between the first and second financial products, and for recording a confirmation of receipt of the request from the other one of the first and second servers; and
a customer device in operative communication with the first and second server, the customer device being operable to transmit a request to the first server to transfer funds from the first financial product to the second financial product over the inter-bank transfer rail, the customer device being further configured to receive an updated balance of the first financial product from the first server and an updated balance of the second financial product from the second server following the transfer, and display the updated balance of the first and second financial products on a common GUI.

8. The system according to claim 7, wherein the customer device is configured to authenticate a customer and to transmit the request to the first server if the customer is authorized to interact with the first and second financial products.

9. The system according to claim 8, wherein the first and second server are configured to respond to requests from the customer device without requiring customer authentication.

10. The system according to claim 8, further comprising a customer profile database storing customer profiles, each customer profile containing a list of financial product with which a customer is authorized to interact, wherein authenticating the customer comprises matching the customer with a customer profile stored in the customer profile database.

11. The system according to claim 10, wherein the customer device is configured to retrieve address information for contacting the first server and second server if the user is authorized to interact with the first and second financial products.

12. The electronic banking system according to claim 7, wherein the customer device is configured to:
transmit a request for transaction information corresponding to the first and second financial products;
receiving the transaction information corresponding to the first and second financial products; and
cause at least some of the received transaction information corresponding to the first and second products to be combined and displayed simultaneously on the GUI.

13. The electronic banking system according to claim 12, wherein the first server is configured to receive the request from the customer device and, responsive thereto, retrieve transaction information corresponding to the first financial product from the first software module; further wherein the second server is configured to receive the request from the customer device and, responsive thereto, retrieve transaction information corresponding to the second financial product from the second software module.

14. A non-transitory computer-readable medium having instructions stored thereon which, when executed by at least one processor, cause the at least one processor to carry out a method for transferring funds between first and second financial products, the first financial product being implemented by a first software module in a first custom bank engine operated by a first financial services merchant, and the second financial product being implemented by a second software module in a second custom bank engine operated by a second financial services merchant, the method comprising:
transmitting, from a customer device, a request to transfer funds from the first financial product to the second financial product;
receiving the request by a first server implementing the first custom bank engine and, responsive to said request, operating the first software module to debit the first financial product and recording the debit in a first private ledger associated with the first custom bank;
transmitting, by the first server via an inter-bank transfer rail, a request to credit the second financial product,
receiving, by a second server implementing the second custom bank engine, via the inter-bank transfer rail, the request to credit the second financial product;
operating the second software module to credit the second financial product, and recording the credit in a second private ledger associated with the second custom bank engine;
recording the debit from the first financial product and the credit to the second financial product in a shared ledger on the inter-bank transfer rail;
transmitting, from the first server to the customer device, an updated balance of the first financial product;
transmitting, from the second server to the customer device, an updated balance of the second financial product; and
displaying the updated balance of the first financial product and the updated balance of the second financial product on a common GUI of the customer device.

15. A electronic banking system allowing transfers between first and second financial products to which a customer has subscribed, the first and a second financial products being operated by independent custom bank engines and offered to customers on a common financial services marketplace, the electronic banking system comprising:
a first server implementing a first custom bank engine, said first custom bank engine comprising a first software module comprising computer code executable to implement the first financial product, and a first private ledger for recording transactions to and from the first financial product;
a second server implementing a second custom bank engine, said second custom bank engine comprising a second software module comprising computer code executable to implement the second financial product, and a second private ledger for recording transactions to and from the second financial product; and
an inter-bank transfer rail operatively connecting the first server and the second server and allowing the first custom bank engine and the second custom bank engine to inter-communicate, the inter-bank transfer rail comprising a shared ledger for recording a request from one of the first or second servers to transfer funds between the first and second financial products, and for recording a confirmation of receipt of the request from the other one of the first and second servers.

16. The electronic banking system according to claim 15, wherein the inter-bank transfer rail comprises computer code executable to:
receive a request from the first server to credit the second financial product following a debit from the first financial product;
record the request to credit the second financial product in the shared ledger;
forward the request to credit the second financial product to the second server;
receive a confirmation from the second server indicating that the request to credit the second financial product was received;
record the confirmation in the shared ledger; and
forward the confirmation to the first server.
